(19) United States
(12) Patent Application Publication
(10) Pub. No.: US 2007/0147832 A1
(43) Pub. Date: Jun. 28, 2007

(54) METHOD OF PROCESSING SUBSTRATE, SUBSTRATE PROCESSING SYSTEM AND SUBSTRATE PROCESSING APPARATUS

(76) Inventors: Kazuhito Shigemori, Kyoto (JP); Koji Kaneyama, Kyoto (JP); Masashi Kanaoka, Kyoto (JP); Tadashi Miyagi, Kyoto (JP); Shuichi Yasuda, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/615,513

(22) Filed: Dec. 22, 2006

(30) Foreign Application Priority Data
Dec. 26, 2005 (JP) 2005-372126

(51) Int. Cl. G03D 5/00

(52) U.S. Cl. 396/611

(57) ABSTRACT

Immediately before or immediately after an alignment process for adjusting an exposure position of a pattern image in an exposure unit compatible with immersion exposure, a dummy substrate for use in the alignment process is transported from the exposure unit to a substrate processing apparatus. In the substrate processing apparatus, a cleaning processing unit cleans and dries the received dummy substrate. The cleaned dummy substrate is transported from the substrate processing apparatus back to the exposure unit. The use of the clean dummy substrate for the execution of the alignment process in the exposure unit reduces contamination of mechanisms within the exposure unit, such as a substrate stage. When the dummy substrate is water-repellent, the cleaning in the substrate processing apparatus restores the water repellency of the dummy substrate.

### BACKGROUND OF THE INVENTION

1. Field of the Invention

The present invention relates to a substrate processing system in which a substrate processing apparatus for performing a resist coating process and a development process on a substrate such as a semiconductor substrate, a glass substrate for a liquid crystal display device, a glass substrate for a photomask, a substrate for an optical disk and the like, and an exposure apparatus for performing an exposure process on a resist-coated substrate are connected to each other. The present invention also relates to a substrate processing method which uses the system, and a substrate processing apparatus for use in the system.

2. Description of the Background Art

As is well known, semiconductor and liquid crystal display products and the like are fabricated by performing a series of processes including cleaning, resist coating, exposure, development, etching, interlayer insulation film formation, heat treatment, dicing and the like on the above-mentioned substrate. Of these various processes, the exposure process is the process of transferring a pattern on a reticle (a mask for exposure) to a resist-coated substrate, and serves as a key part of a so-called photolithography process. Because the pattern is extremely fine, so-called step-and-repeat exposure, rather than single exposure of the entire wafer, is typically performed in such a manner that the wafer is exposed repeatedly in batches of several chips.

With the rapid increase in the density of semiconductor devices and the like in recent years, there has been a strong demand to make the mask pattern finer. Thus, light sources for an exposure apparatus for performing the exposure process which become dominant are deep-UV light sources such as a KrF excimer laser light source and an ArF excimer laser light source which emit light with relatively short wavelengths in place of conventional UV lamps. However, even the ArF excimer laser light source is insufficient to meet the requirement for much finer patterns of late. To solve such a problem, it is conceivable to adopt a light source which emits light with a shorter wavelengths, e.g. an F2 laser light source, for the exposure apparatus. An immersion exposure processing method as disclosed in International Publication No. WO 99/49504 in the form of a pamphlet is proposed as an exposure technique which is capable of providing the much finer patterns while reducing burdens in cost.

The immersion exposure processing method is the technique of performing “immersion exposure,” with the space between a projection optical system and a substrate filled with a liquid having a refractive index n (e.g., deionized water with n=1.44) greater than that of the atmosphere (n=1), to increase numerical aperture, thereby improving resolution. This immersion exposure processing method can provide an equivalent wavelength of 134 nm when a conventional ArF excimer laser light source (which emits light with a wavelength of 193 nm) is diverted directly, to achieve the finer pattern of the resist mask while suppressing growing burdens in cost.

It is important for such an immersion exposure processing method as well as for a conventional dry exposure process to precisely align a pattern image of the mask and an exposure area on the substrate with each other. Thus, an alignment process for calibrating the position of a substrate stage and a reticle position to adjust the exposure position of the pattern image is performed also in an exposure apparatus compatible with the immersion exposure processing method. In the exposure apparatus compatible with the immersion exposure process, however, there is apprehension that liquid (liquid for immersion) enters the inside of the substrate stage during the alignment process to cause a trouble. To solve this problem, Japanese Patent Application Laid-Open No. 2005-268747 discloses a technique such that a dummy substrate is placed on the substrate stage for the execution of the alignment process. This prevents the liquid from entering the inside of the stage because the dummy substrate closes a recessed portion of the stage, as in the conventional exposure process.

In the alignment process disclosed in Japanese Patent Application Laid-Open No. 2005-268747, the liquid is prevented from entering the inside of the stage, but there is a likelihood that the liquid comes in contact with the dummy substrate itself to remain in the form of droplets on the substrate after the alignment process. Such droplets may adsorb extraneous matter such as particles to result in apprehension that only the extraneous matter adheres as contaminants to the dummy substrate after the liquid dries. The execution of the alignment process using the dummy substrate contaminated in this manner creates a problem that the substrate stage and its surroundings are contaminated.

Also, Japanese Patent Application Laid-Open No. 2005-268747 discloses that the dummy substrate preferably has water repellency. However, the extraneous matter adhering to the surface of the dummy substrate to contaminate the dummy substrate impairs the water repellency to make it difficult to hold the liquid for immersion during the alignment process. Japanese Patent Application Laid-Open No. 2005-268747 discloses the replacement of a dummy substrate whose water repellency is degraded. However, the replacement of dummy substrates whose water repellency is degraded due to contamination one by one gives rise to the significant increase in cost.

### SUMMARY OF THE INVENTION

The present invention is intended for a method of processing a substrate, the method including transporting a substrate subjected to a resist coating process in a substrate processing apparatus to an exposure apparatus to expose the substrate in a pattern in the exposure apparatus, and then transporting the substrate back to the substrate processing apparatus to perform a development process on the substrate in the substrate processing apparatus.

According to the present invention, the method comprises the steps of: a) transporting a dummy substrate from the exposure apparatus to the substrate processing apparatus, the dummy substrate being used during the adjustment of an exposure position of a pattern image in the exposure apparatus; b) cleaning the dummy substrate in the substrate processing apparatus; and c) transporting the dummy substrate subjected to the cleaning from the substrate processing apparatus back to the exposure apparatus.

This method achieves the adjustment of the exposure position by using the clean dummy substrate subjected to the cleaning to reduce contamination of mechanisms within the exposure apparatus.

Preferably, the step b) is performed immediately before and/or immediately after the adjustment of the exposure position in the exposure apparatus.

This achieves the adjustment of the exposure position by using the dummy substrate immediately after the cleaning and/or allows the cleaning of the dummy substrate before droplets dry if the droplets adhere to the dummy substrate during the adjustment of the exposure position.

The present invention is also intended for a substrate processing system including a substrate processing apparatus for performing a resist coating process and a development process on a substrate and an exposure apparatus for performing an exposure process on a resist-coated substrate, the substrate processing apparatus and the exposure apparatus being connected to each other.

According to the present invention, the substrate processing system comprises: a housing part provided in the exposure apparatus for housing a dummy substrate for use during the adjustment of an exposure position of a pattern image; a first transport element provided in the exposure apparatus for transporting the dummy substrate between the housing part and the substrate processing apparatus; a cleaning part provided in the substrate processing apparatus for cleaning the dummy substrate; and a second transport element provided in the substrate processing apparatus for transporting the dummy substrate received from the first transport element to the cleaning part and for transferring the cleaned dummy substrate received from the cleaning part to the first transport element.

This substrate processing system achieves the adjustment of the exposure position by using the clean dummy substrate to reduce contamination of mechanisms within the exposure apparatus.

The present invention is also intended for a substrate processing apparatus for performing a resist coating process and a development process on a substrate, the substrate processing apparatus being disposed adjacent to an exposure apparatus for performing an exposure process on a substrate.

According to the present invention, the substrate processing apparatus comprises: a cleaning part for cleaning a dummy substrate, the dummy substrate being used during the adjustment of an exposure position of a pattern image in the exposure apparatus; and a transport element for transporting the dummy substrate received from the exposure apparatus to the cleaning part and for transferring the cleaned dummy substrate received from the cleaning part to the exposure apparatus.

This substrate processing apparatus achieves the adjustment of the exposure position by using the clean dummy substrate to reduce contamination of mechanisms within the exposure apparatus.

It is therefore an object of the present invention to provide a substrate processing method, a substrate processing apparatus and a substrate processing system which are capable of reducing contamination of mechanisms within an exposure apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate processing apparatus according to the present invention;

FIG. 2 is a front view of a liquid processing part;

FIG. 3 is a front view of a thermal processing part;

FIG. 4 is a view showing a construction around substrate rest parts;

FIG. 5A is a plan view of a transport robot;

FIG. 5B is a front view of the transport robot;

FIG. 6 is a view for illustrating a construction of a cleaning processing unit;

FIG. 7A is a side sectional view of a heating part with a temporary substrate rest part;

FIG. 7B is a plan view of the heating part with the temporary substrate rest part;

FIG. 8 is a side view of an interface block;

FIG. 9 is a schematic plan view showing a construction of an exposure unit connected in adjacent relation to the substrate processing apparatus;

FIG. 10 is a schematic block diagram showing a control mechanism;

FIG. 11 is a functional block diagram showing functional processing parts implemented in a substrate processing system;

FIG. 12 is a flow chart showing a procedure for cleaning of a dummy substrate; and

FIG. 13 is a view showing an instance in which a cleaning processing unit is placed in the interface block.

### DESCRIPTION OF THE PREFERRED EMBODIMENTS

A preferred embodiment according to the present invention will now be described in detail with reference to the drawings.

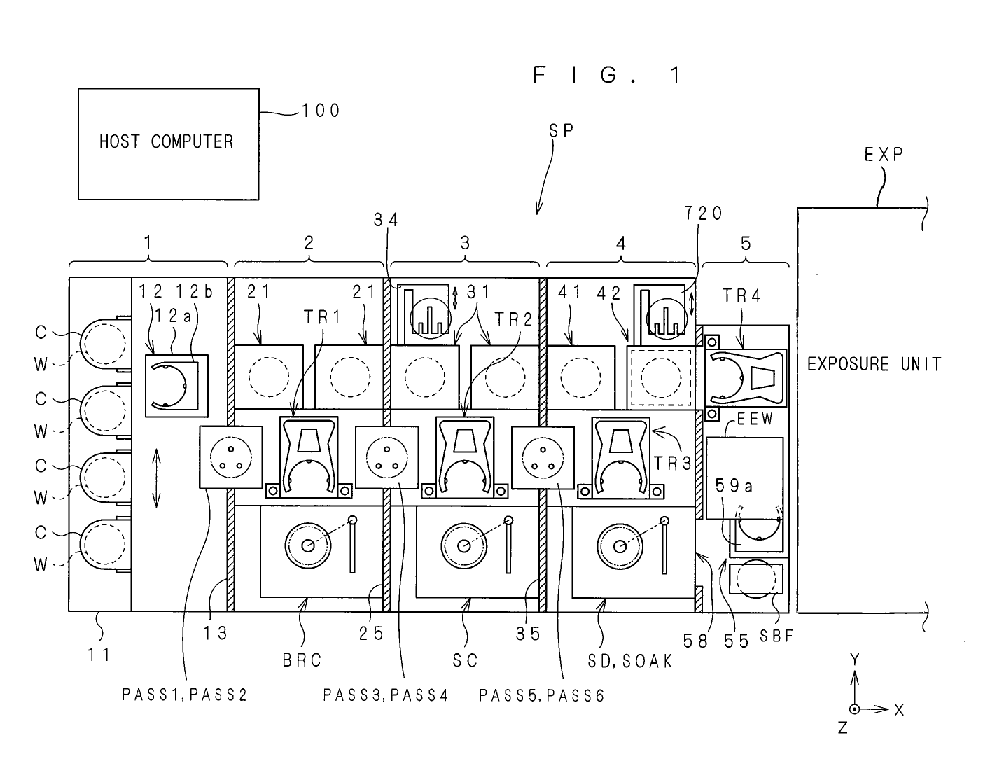

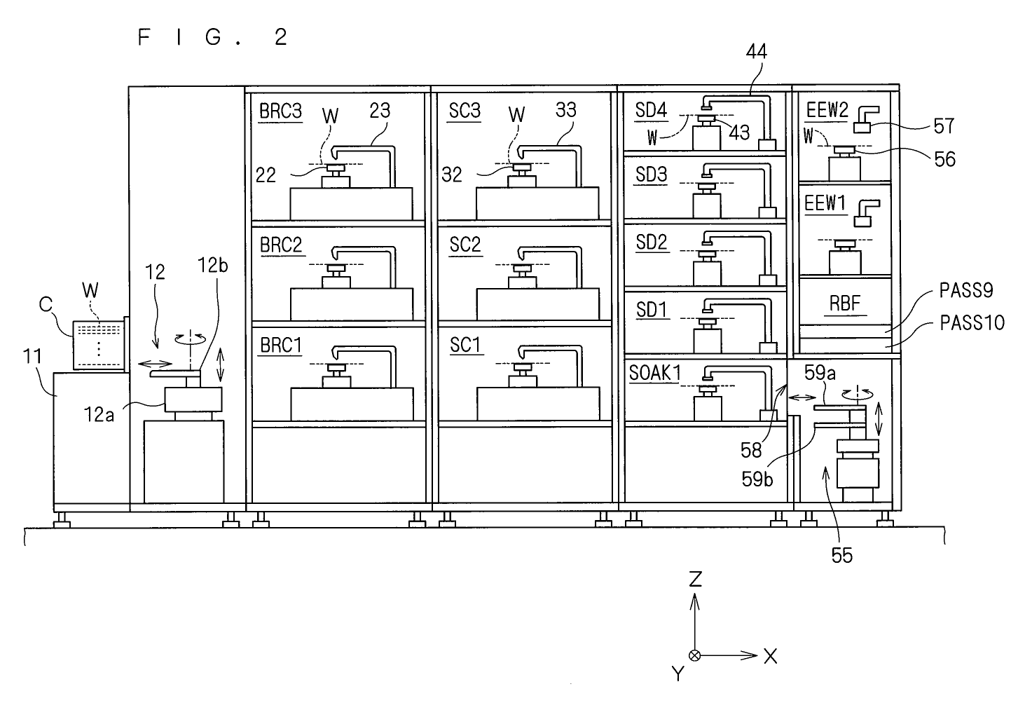

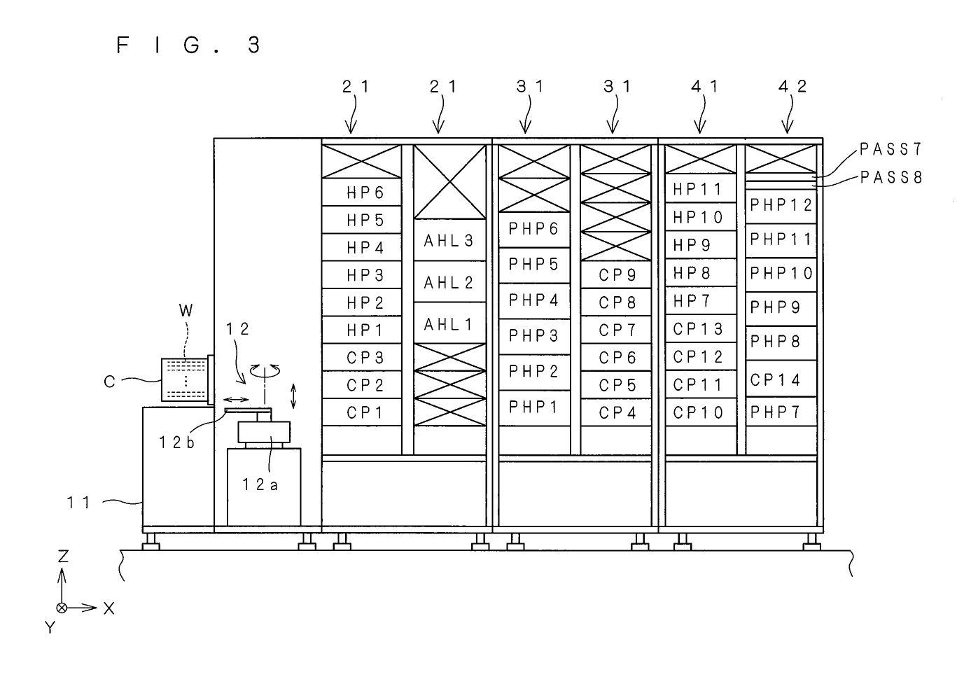

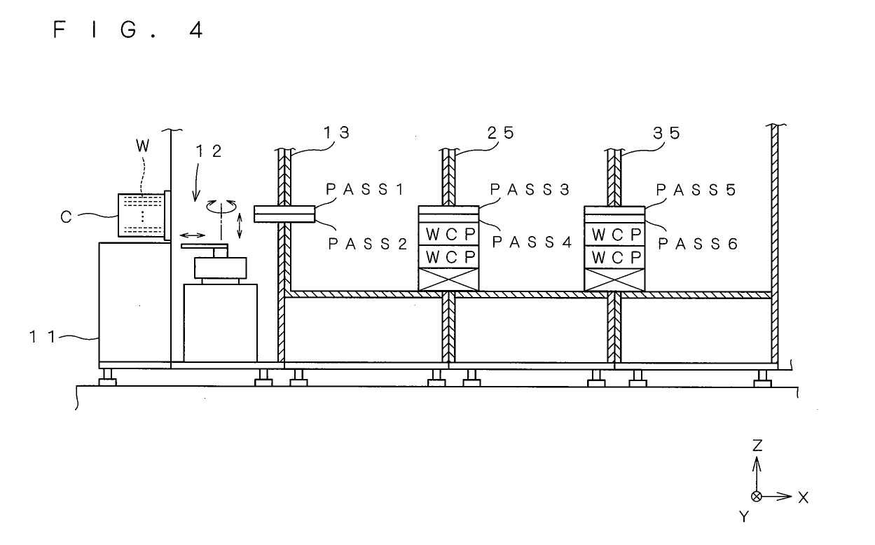

FIG. 1 is a plan view of a substrate processing apparatus SP according to the present invention. FIG. 2 is a front view of a liquid processing part in the substrate processing apparatus SP. FIG. 3 is a front view of a thermal processing part in the substrate processing apparatus SP. FIG. 4 is a view showing a construction around substrate rest parts. An XYZ rectangular coordinate system in which an XY plane is defined as the horizontal plane and a Z axis is defined to extend in the vertical direction is additionally shown in FIG. 1 and the subsequent figures for purposes of clarifying the directional relationship therebetween.

The substrate processing apparatus SP is an apparatus (a so-called coater-and-developer) for forming an anti-reflective film and a photoresist film on substrates such as semiconductor wafers by coating and for performing a development process on substrates subjected to a pattern exposure process. The substrates to be processed by the substrate processing apparatus SP according to the present invention are not limited to semiconductor wafers, but may include glass substrates for a liquid crystal display device, and the like.

The substrate processing apparatus SP according to the preferred embodiment includes an indexer block 1, a BARC (Bottom Anti-Reflective Coating) block 2, a resist coating block 3, a development processing block 4, and an interface block 5. In the substrate processing apparatus SP, the five processing blocks 1 to 5 are arranged in side-by-side relation. An exposure unit (or stepper) EXP for performing an exposure process on a resist-coated substrate is provided and connected to the interface block 5. That is, the substrate processing apparatus SP is disposed adjacent to the exposure unit EXP. The substrate processing apparatus SP according to the preferred embodiment and the exposure unit EXP are connected via LAN lines to a host computer 100.

The indexer block 1 is a processing block for transferring unprocessed substrates received from the outside of the substrate processing apparatus SP outwardly to the BARC block 2 and the resist coating block 3, and for transporting processed substrates received from the development processing block 4 to the outside of the substrate processing apparatus SP. The indexer block 1 includes a table 11 for placing thereon a plurality of (in this preferred embodiment, four) cassettes (or carriers) C in juxtaposition, and a substrate transfer mechanism 12 for taking an unprocessed substrate W out of each of the cassettes C and for storing a processed substrate W into each of the cassettes C. The substrate transfer mechanism 12 includes a movable base 12a movable horizontally (in the Y direction) along the table 11, and a holding arm 12b mounted on the movable base 12a and for holding a substrate W in a horizontal position. The holding arm 12b is capable of moving upwardly and downwardly (in the Z direction) over the movable base 12a, pivoting within a horizontal plane and moving back and forth in the direction of the pivot radius. Thus, the substrate transfer mechanism 12 can cause the holding arm 12b to gain access to each of the cassettes C, thereby taking an unprocessed substrate W out of each cassette C and storing a processed substrate W into each cassette C. The cassettes C may be of the following types: an SMIF (standard mechanical interface) pod, and an OC (open cassette) which exposes stored substrates W to the atmosphere, in addition to a FOUP (front opening unified pod) which stores substrates W in an enclosed or sealed space.

The BARC block 2 is provided in adjacent relation to the indexer block 1. A partition 13 for closing off the communication of atmosphere is provided between the indexer block 1 and the BARC block 2. The partition 13 is provided with a pair of vertically arranged substrate rest parts PASS1 and PASS2 each for placing a substrate W thereon for the transfer of the substrate W between the indexer block 1 and the BARC block 2.

The upper substrate rest part PASS1 is used for the transport of a substrate W from the indexer block 1 to the BARC block 2. The substrate rest part PASS1 includes three support pins. The substrate transfer mechanism 12 of the indexer block 1 places an unprocessed substrate W taken out of one of the cassettes C onto the three support pins of the substrate rest part PASS1. A transport robot TR1 of the BARC block 2 to be described later receives the substrate W placed on the substrate rest part PASS1. The lower substrate rest part PASS2, on the other hand, is used for the transport of a substrate W from the BARC block 2 to the indexer block 1. The substrate rest part PASS2 also includes three support pins. The transport robot TR1 of the BARC block 2 places a processed substrate W onto the three support pins of the substrate rest part PASS2. The substrate transfer mechanism 12 receives the substrate W placed on the substrate rest part PASS2 and stores the substrate W into one of the cassettes C. Pairs of substrate rest parts PASS3 to PASS10 to be described later are similar in construction to the pair of substrate rest parts PASS1 and PASS2.

The substrate rest parts PASS1 and PASS2 extend through the partition 13. Each of the substrate rest parts PASS1 and PASS2 includes an optical sensor (not shown) for detecting the presence or absence of a substrate W thereon. Based on a detection signal from each of the sensors, a judgment is made as to whether or not the substrate transfer mechanism 12 and the transport robot TR1 of the BARC block 2 stand ready to transfer and receive a substrate W to and from the substrate rest parts PASS1 and PASS2.

Next, the BARC block 2 will be described. The BARC block 2 is a processing block for forming an anti-reflective film by coating at the bottom of a photoresist film (i.e., as an undercoating film for the photoresist film) to reduce standing waves or halation occurring during exposure. The BARC block 2 includes a bottom coating processor BRC for coating the surface of a substrate W with the anti-reflective film, a pair of thermal processing towers 21 for performing a thermal process which accompanies the formation of the anti-reflective film by coating, and the transport robot TR1 for transferring and receiving a substrate W to and from the bottom coating processor BRC and the pair of thermal processing towers 21.

In the BARC block 2, the bottom coating processor BRC and the pair of thermal processing towers 21 are arranged on opposite sides of the transport robot TR1. Specifically, the bottom coating processor BRC is on the front side of the substrate processing apparatus SP, and the pair of thermal processing towers 21 are on the rear side thereof. Additionally, a thermal barrier not shown is provided on the front side of the pair of thermal processing towers 21. Thus, the thermal effect of the pair of thermal processing towers 21 upon the bottom coating processor BRC is avoided by spacing the bottom coating processor BRC apart from the pair of thermal processing towers 21 and by providing the thermal barrier.

As shown in FIG. 2, the bottom coating processor BRC includes three coating processing units BRC1, BRC2 and BRC3 similar in construction to each other and arranged in stacked relation in bottom-to-top order. The three coating processing units BRC1, BRC2 and BRC3 are collectively referred to as the bottom coating processor BRC, unless otherwise identified. Each of the coating processing units BRC1, BRC2 and BRC3 includes a spin chuck 22 for rotating a substrate W in a substantially horizontal plane while holding the substrate W in a substantially horizontal position under suction, a coating nozzle 23 for applying a coating solution for the anti-reflective film onto the substrate W held on the spin chuck 22, a spin motor (not shown) for rotatably driving the spin chuck 22, a cup (not shown) surrounding the substrate W held on the spin chuck 22, and the like.

As shown in FIG. 3, one of the thermal processing towers 21 which is closer to the indexer block 1 includes six hot plates HP1 to HP6 for heating a substrate W up to a predetermined temperature, and cool plates CP1 to CP3 for cooling a heated substrate W down to a predetermined temperature and maintaining the substrate W at the predetermined temperature. The cool plates CP1 to CP3 and the hot plates HP1 to HP6 are arranged in stacked relation in bottom-to-top order in this thermal processing tower 21. The other of the thermal processing towers 21 which is farther from the indexer block 1 includes three adhesion promotion processing parts AHL1 to AHL3 arranged in stacked relation in bottom-to-top order for thermally processing a substrate W in a vapor atmosphere of HMDS (hexamethyl disilazane) to promote the adhesion of the resist film to the substrate W. The locations indicated by the cross marks (x) in FIG. 3 are occupied by a piping and wiring section or reserved as empty space for future addition of processing units.

Thus, stacking the coating processing units BRC1 to BRC3 and the thermal processing units (the hot plates HP1 to HP6, the cool plates CP1 to CP3, and the adhesion promotion processing parts AHL1 to AHL3 in the BARC block 2) in tiers provides smaller space occupied by the substrate processing apparatus SP to reduce the footprint thereof. The side-by-side arrangement of the pair of thermal processing towers 21 is advantageous in facilitating the maintenance of the thermal processing units and in eliminating the need for extension of ducting and power supply equipment necessary for the thermal processing units to a much higher position.

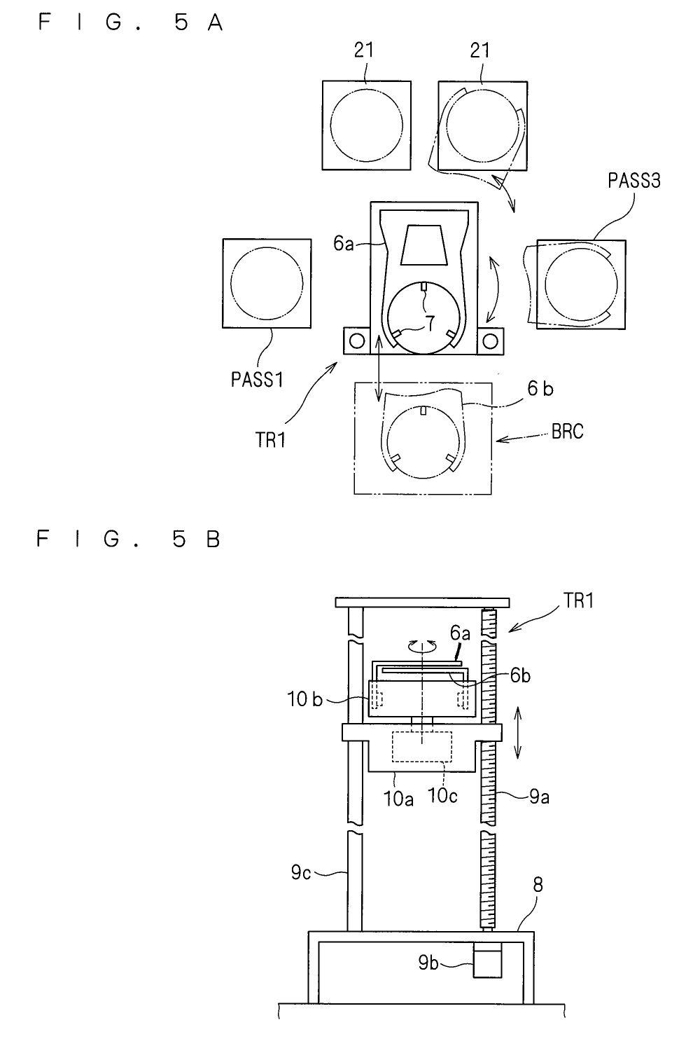

FIGS. 5A and 5B are views for illustrating the transport robot TR1 provided in the BARC block 2. FIG. 5A is a plan view of the transport robot TR1, and FIG. 5B is a front view of the transport robot TR1. The transport robot TR1 includes a pair of (upper and lower) holding arms 6a and 6b in proximity to each other for holding a substrate W in a substantially horizontal position. Each of the holding arms 6a and 6b includes a distal end portion of a substantially C-shaped plan configuration, and a plurality of pins 7 projecting inwardly from the inside of the substantially C-shaped distal end portion for supporting the peripheral edge of a substrate W from below.

The transport robot TR1 further includes a base 8 fixedly mounted on an apparatus base (or an apparatus frame). A guide shaft 9c is mounted upright on the base 8, and a threaded shaft 9a is rotatably mounted and supported upright on the base 8. A motor 9b for rotatably driving the threaded shaft 9a is fixedly mounted to the base 8. A lift 10a is in threaded engagement with the threaded shaft 9a, and is freely slidable relative to the guide shaft 9c. With such an arrangement, the motor 9b rotatably drives the threaded shaft 9a, whereby the lift 10a is guided by the guide shaft 9c to move up and down in a vertical direction (in the Z direction).

An arm base 10b is mounted on the lift 10a pivotably about a vertical axis. The lift 10a contains a motor 10c for pivotably driving the arm base 10b. The pair of (upper and lower) holding arms 6a and 6b described above are provided on the arm base 10b. Each of the holding arms 6a and 6b is independently movable back and forth in a horizontal direction (in the direction of the pivot radius of the arm base 10b) by a sliding drive mechanism (not shown) mounted to the arm base 10b.

With such an arrangement, the transport robot TR1 is capable of causing each of the pair of holding arms 6a and 6b to independently gain access to the substrate rest parts PASS1 and PASS2, the thermal processing units provided in the thermal processing towers 21, the coating processing units provided in the bottom coating processor BRC, and the substrate rest parts PASS3 and PASS4 to be described later, thereby transferring and receiving substrates W to and from the above-mentioned parts and units, as shown in FIG. 5A.

Next, the resist coating block 3 will be described. The resist coating block 3 is provided so as to be sandwiched between the BARC block 2 and the development processing block 4. A partition 25 for closing off the communication of atmosphere is also provided between the resist coating block 3 and the BARC block 2. The partition 25 is provided with the pair of vertically arranged substrate rest parts PASS3 and PASS4 each for placing a substrate W thereon for the transfer of the substrate W between the BARC block 2 and the resist coating block 3. The substrate rest parts PASS3 and PASS4 are similar in construction to the above-mentioned substrate rest parts PASS1 and PASS2.

The upper substrate rest part PASS3 is used for the transport of a substrate W from the BARC block 2 to the resist coating block 3. Specifically, a transport robot TR2 of the resist coating block 3 receives the substrate W placed on the substrate rest part PASS3 by the transport robot TR1 of the BARC block 2. The lower substrate rest part PASS4, on the other hand, is used for the transport of a substrate W from the resist coating block 3 to the BARC block 2. Specifically, the transport robot TR1 of the BARC block 2 receives the substrate W placed on the substrate rest part PASS4 by the transport robot TR2 of the resist coating block 3.

The substrate rest parts PASS3 and PASS4 extend through the partition 25. Each of the substrate rest parts PASS3 and PASS4 includes an optical sensor (not shown) for detecting the presence or absence of a substrate W thereon. Based on a detection signal from each of the sensors, a judgment is made as to whether or not the transport robots TR1 and TR2 stand ready to transfer and receive a substrate W to and from the substrate rest parts PASS3 and PASS4. A pair of (upper and lower) cool plates WCP of a water-cooled type for roughly cooling a substrate W are provided under the substrate rest parts PASS3 and PASS4, and extend through the partition 25 (See FIG. 4).

The resist coating block 3 is a processing block for applying a resist onto a substrate W coated with the anti-reflective film by the BARC block 2 to form a resist film. In this preferred embodiment, a chemically amplified resist is used as the photoresist. The resist coating block 3 includes a resist coating processor SC for forming the resist film by coating on the anti-reflective film serving as the undercoating film, a pair of thermal processing towers 31 for performing a thermal process which accompanies the resist coating process, and the transport robot TR2 for transferring and receiving a substrate W to and from the resist coating processor SC and the pair of thermal processing towers 31.

In the resist coating block 3, the resist coating processor SC and the pair of thermal processing towers 31 are arranged on opposite sides of the transport robot TR2. Specifically, the resist coating processor SC is on the front side of the substrate processing apparatus SP, and the pair of thermal processing towers 31 are on the rear side thereof. Additionally, a thermal barrier not shown is provided on the front side of the pair of thermal processing towers 31. Thus, the thermal effect of the pair of thermal processing towers 31 upon the resist coating processor SC is avoided by spacing the resist coating processor SC apart from the pair of thermal processing towers 31 and by providing the thermal barrier.

As shown in FIG. 2, the resist coating processor SC includes three coating processing units SC1, SC2 and SC3 similar in construction to each other and arranged in stacked relation in bottom-to-top order. The three coating processing units SC1, SC2 and SC3 are collectively referred to as the resist coating processor SC, unless otherwise identified. Each of the coating processing units SC1, SC2 and SC3 includes a spin chuck 32 for rotating a substrate W in a substantially horizontal plane while holding the substrate W in a substantially horizontal position under suction, a coating nozzle 33 for applying a resist solution onto the substrate W held on the spin chuck 32, a spin motor (not shown) for rotatably driving the spin chuck 32, a cup (not shown) surrounding the substrate W held on the spin chuck 32, and the like.

As shown in FIG. 3, one of the thermal processing towers 31 which is closer to the indexer block 1 includes six heating parts PHP1 to PHP6 arranged in stacked relation in bottom-to-top order for heating a substrate W up to a predetermined temperature. The other of the thermal processing towers 31 which is farther from the indexer block 1 includes cool plates CP4 to CP9 arranged in stacked relation in bottom-to-top order for cooling a heated substrate W down to a predetermined temperature and maintaining the substrate W at the predetermined temperature.

Each of the heating parts PHP1 to PHP6 is a thermal processing unit including, in addition to an ordinary hot plate for heating a substrate W placed thereon, a temporary substrate rest part for placing a substrate W in an upper position spaced apart from the hot plate, and a local transport mechanism 34 (See FIG. 1) for transporting a substrate W between the hot plate and the temporary substrate rest part. The local transport mechanism 34 is capable of moving up and down and moving back and forth, and includes a mechanism for cooling down a substrate W being transported by circulating cooling water therein.

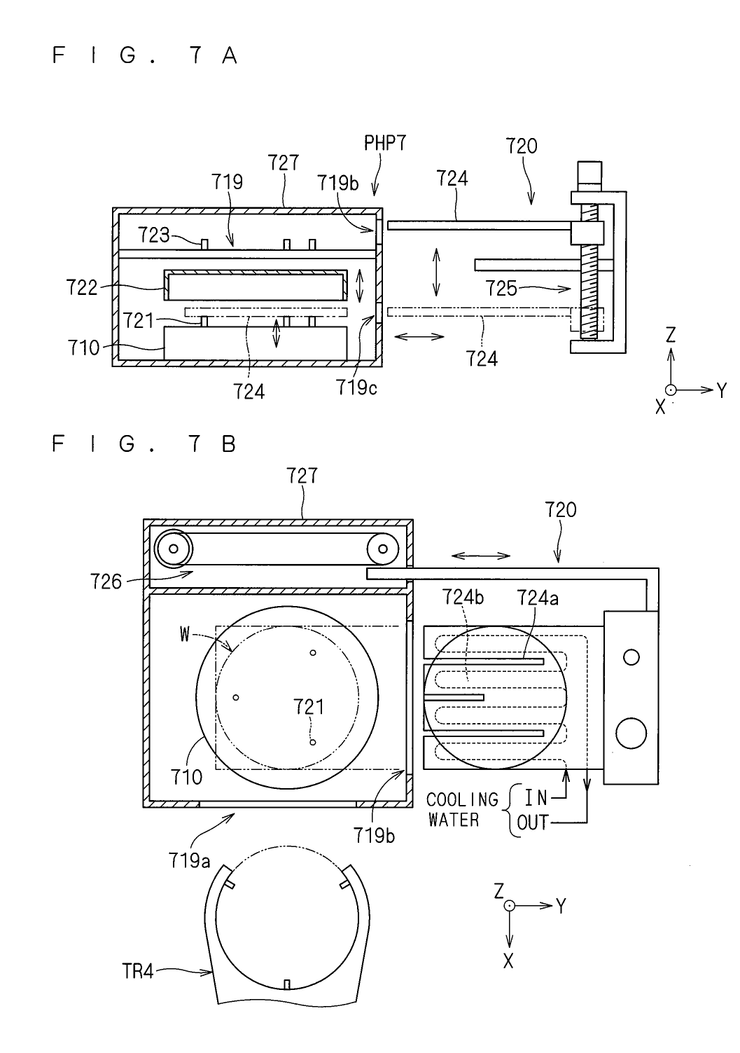

The local transport mechanism 34 is provided on the opposite side of the above-mentioned hot plate and the temporary substrate rest part from the transport robot TR2, that is, on the rear side of the substrate processing apparatus SP. The temporary substrate rest part has both an open side facing the transport robot TR2 and an open side facing the local transport mechanism 34. The hot plate, on the other hand, has only an open side facing the local transport mechanism 34, and a closed side facing the transport robot TR2. Thus, both of the transport robot TR2 and the local transport mechanism 34 can gain access to the temporary substrate rest part, but only the local transport mechanism 34 can gain access to the hot plate. The heating parts PHP1 to PHP6 are generally similar in construction (FIGS. 7A and 7B) to heating parts PHP7 to PHP12 in the development processing block 4 to be described later.

A substrate W is transported into each of the above-mentioned heating parts PHP1 to PHP6 having such a construction in a manner to be described below. First, the transport robot TR2 places a substrate W onto the temporary substrate rest part. Subsequently, the local transport mechanism 34 receives the substrate W from the temporary substrate rest part to transport the substrate W to the hot plate. The hot plate performs a heating process on the substrate W. The local transport mechanism 34 takes out the substrate W subjected to the heating process by the hot plate, and transports the substrate W to the temporary substrate rest part. During the transport, the substrate W is cooled down by the cooling function of the local transport mechanism 34. Thereafter, the transport robot TR2 takes out the substrate W subjected to the heating process and transported to the temporary substrate rest part.

In this manner, the transport robot TR2 transfers and receives the substrate W to and from only the temporary substrate rest part held at room temperature in each of the heating parts PHP1 to PHP6, but does not transfer and receive the substrate W directly to and from the hot plate. This avoids the temperature rise of the transport robot TR2. The hot plate having only the open side facing the local transport mechanism 34 prevents the heat atmosphere leaking out of the hot plate from affecting the transport robot TR2 and the resist coating processor SC. The transport robot TR2 transfers and receives a substrate W directly to and from the cool plates CP4 to CP9.

The transport robot TR2 is precisely identical in construction with the transport robot TR1. Thus, the transport robot TR2 is capable of causing each of a pair of holding arms thereof to independently gain access to the substrate rest parts PASS3 and PASS4, the thermal processing units provided in the thermal processing towers 31, the coating processing units provided in the resist coating processor SC, and the substrate rest parts PASS5 and PASS6 to be described later, thereby transferring and receiving substrates W to and from the above-mentioned parts and units.

Next, the development processing block 4 will be described. The development processing block 4 is provided so as to be sandwiched between the resist coating block 3 and the interface block 5. A partition 35 for closing off the communication of atmosphere is also provided between the resist coating block 3 and the development processing block 4. The partition 35 is provided with the pair of vertically arranged substrate rest parts PASS5 and PASS6 each for placing a substrate W thereon for the transfer of the substrate W between the resist coating block 3 and the development processing block 4. The substrate rest parts PASS5 and PASS6 are similar in construction to the above-mentioned substrate rest parts PASS1 and PASS2.

The upper substrate rest part PASS5 is used for the transport of a substrate W from the resist coating block 3 to the development processing block 4. Specifically, a transport robot TR3 of the development processing block 4 receives the substrate W placed on the substrate rest part PASS5 by the transport robot TR2 of the resist coating block 3. The lower substrate rest part PASS6, on the other hand, is used for the transport of a substrate W from the development processing block 4 to the resist coating block 3. Specifically, the transport robot TR2 of the resist coating block 3 receives the substrate W placed on the substrate rest part PASS6 by the transport robot TR3 of the development processing block 4.

The substrate rest parts PASS5 and PASS6 extend through the partition 35. Each of the substrate rest parts PASS5 and PASS6 includes an optical sensor (not shown) for detecting the presence or absence of a substrate W thereon. Based on a detection signal from each of the sensors, a judgment is made as to whether or not the transport robots TR2 and TR3 stand ready to transfer and receive a substrate W to and from the substrate rest parts PASS5 and PASS6. A pair of (upper and lower) cool plates WCP of a water-cooled type for roughly cooling a substrate W are provided under the substrate rest parts PASS5 and PASS6, and extend through the partition 35 (See FIG. 4).

The development processing block 4 is a processing block for performing a development process on a substrate W subjected to an exposure process. The development processing block 4 is also capable of cleaning and drying a substrate W subjected to an immersion exposure process. The development processing block 4 includes a development processor SD for applying a developing solution onto a substrate W exposed in a pattern to perform the development process, a cleaning processor SOAK for performing a cleaning process and a drying process on a substrate W subjected to the immersion exposure process, a pair of thermal processing towers 41 and 42 for performing a thermal process which accompanies the development process, and the transport robot TR3 for transferring and receiving a substrate W to and from the development processor SD, the cleaning processor SOAK and the pair of thermal processing towers 41 and 42. The transport robot TR3 is precisely identical in construction with the above-mentioned transport robots TR1 and TR2.

As shown in FIG. 2, the development processor SD includes four development processing units SD1, SD2, SD3 and SD4 similar in construction to each other and arranged in stacked relation in bottom-to-top order. The four development processing units SD1 to SD4 are collectively referred to as the development processor SD, unless otherwise identified. Each of the development processing units SD1 to SD4 includes a spin chuck 43 for rotating a substrate W in a substantially horizontal plane while holding the substrate W in a substantially horizontal position under suction, a nozzle 44 for applying the developing solution onto the substrate W held on the spin chuck 43, a spin motor (not shown) for rotatably driving the spin chuck 43, a cup (not shown) surrounding the substrate W held on the spin chuck 43, and the like.

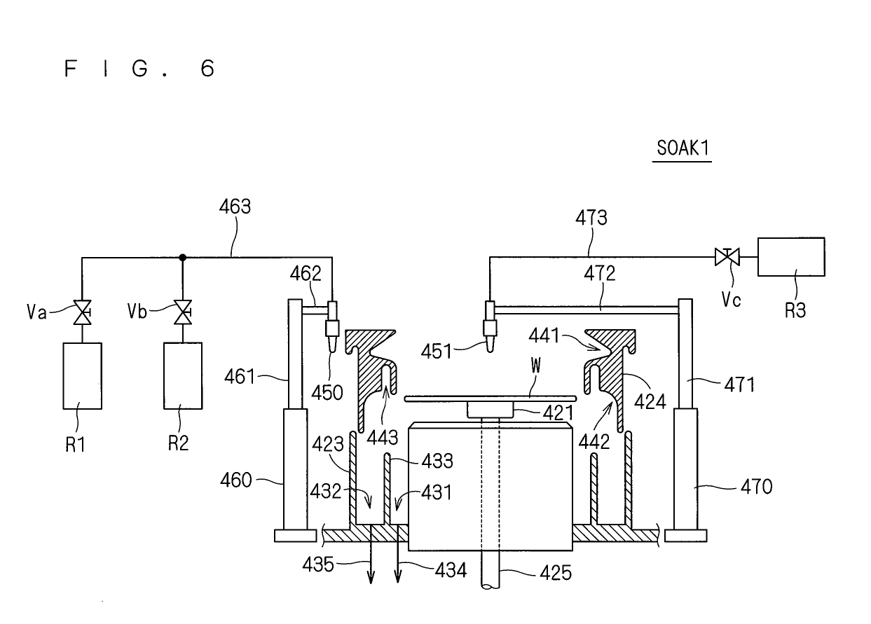

The cleaning processor SOAK includes a single cleaning processing unit SOAK1. As shown in FIG. 2, the cleaning processing unit SOAK1 is disposed under the development processing unit SD1. FIG. 6 is a view for illustrating the construction of the cleaning processing unit SOAK1. The cleaning processing unit SOAK1 includes a spin chuck 421 for rotating a substrate W about a vertical rotation axis passing through the center of the substrate W while holding the substrate W in a horizontal position.

The spin chuck 421 is fixed on the upper end of a rotary shaft 425 rotated by an electric motor not shown. The spin chuck 421 is formed with a suction passage (not shown). With the substrate W placed on the spin chuck 421, exhausting air from the suction passage allows the lower surface of the substrate W to be vacuum-held on the spin chuck 421, whereby the substrate W is held in a horizontal position.

A first pivoting motor 460 is provided on one side of the spin chuck 421. A first pivoting shaft 461 is connected to the first pivoting motor 460. A first arm 462 is coupled to the first pivoting shaft 461 so as to extend in a horizontal direction, and a cleaning processing nozzle 450 is provided on a distal end of the first arm 462. The first pivoting motor 460 drives the first pivoting shaft 461 to rotate, thereby pivoting the first arm 462, whereby the cleaning processing nozzle 450 moves to over the substrate W held by the spin chuck 421.

A tip of a cleaning supply pipe 463 is connected in communication with the cleaning processing nozzle 450. The cleaning supply pipe 463 is connected in communication with a cleaning liquid supply source R1 and a surface preparation liquid supply source R2 through a valve Va and a valve Vb, respectively. Controlling the opening and closing of the valves Va and Vb allows the selection of a processing liquid to be supplied to the cleaning supply pipe 463 and the adjustment of the amount of supply thereof. Specifically, a cleaning liquid is supplied to the cleaning supply pipe 463 by opening the valve Va, and a surface preparation liquid is supplied to the cleaning supply pipe 463 by opening the valve Vb.

The cleaning liquid supplied from the cleaning liquid supply source R1 or the surface preparation liquid supplied from the surface preparation liquid supply source R2 is fed through the cleaning supply pipe 463 to the cleaning processing nozzle 450. This provides the cleaning liquid or the surface preparation liquid from the cleaning processing nozzle 450 to the surface of the substrate W. Examples of the cleaning liquid used herein include deionized water, a solution of a complex (ionized) in deionized water, and the like. Examples of the surface preparation liquid used herein include hydrofluoric acid, and the like. A two-fluid nozzle which mixes droplets into a gas to eject the mixture may be used as the cleaning processing nozzle 450. Another construction may be employed such that a brush is used to clean the surface of the substrate W while deionized water serving as the cleaning liquid is applied to the surface of the substrate W.

A second pivoting motor 470 is provided on a different side of the spin chuck 421 than the above-mentioned side. A second pivoting shaft 471 is connected to the second pivoting motor 470. A second arm 472 is coupled to the second pivoting shaft 471 so as to extend in a horizontal direction, and a drying processing nozzle 451 is provided on a distal end of the second arm 472. The second pivoting motor 470 drives the second pivoting shaft 471 to rotate, thereby pivoting the second arm 472, whereby the drying processing nozzle 451 moves to over the substrate W held by the spin chuck 421.

A tip of a drying supply pipe 473 is connected in communication with the drying processing nozzle 451. The drying supply pipe 473 is connected in communication with an inert gas supply source R3 through a valve Vc. Controlling the opening and closing of the valve Vc allows the adjustment of the amount of inert gas to be supplied to the drying supply pipe 473.

The inert gas supplied from the inert gas supply source R3 is fed through the drying supply pipe 473 to the drying processing nozzle 451. This provides the inert gas from the drying processing nozzle 451 to the surface of the substrate W. Examples of the inert gas used herein include nitrogen gas (N₂) and argon gas (Ar).

When supplying the cleaning liquid or the surface preparation liquid to the surface of the substrate W, the cleaning processing nozzle 450 is positioned over the substrate W held by the spin chuck 421 whereas the drying processing nozzle 451 is retracted to a predetermined position. When supplying the inert gas to the surface of the substrate W, on the other hand, the drying processing nozzle 451 is positioned over the substrate W held by the spin chuck 421 whereas the cleaning processing nozzle 450 is retracted to a predetermined position, as shown in FIG. 6.

The substrate W held by the spin chuck 421 is surrounded by a processing cup 423. A cylindrical partition wall 433 is provided inside the processing cup 423. A drainage space 431 for draining the processing liquid (the cleaning liquid or the surface preparation liquid) used for the processing of the substrate W is formed inside the partition wall 433 so as to surround the spin chuck 421. A collected liquid space 432 for collecting the processing liquid used for the processing of the substrate W is formed between the outer wall of the processing cup 423 and the partition wall 433 so as to surround the drainage space 431.

A drainage pipe 434 for guiding the processing liquid to a drainage processing apparatus (not shown) is connected to the drainage space 431, and a collection pipe 435 for guiding the processing liquid to a collection processing apparatus (not shown) is connected to the collected liquid space 432.

A splash guard 424 for preventing the processing liquid from the substrate W from splashing outwardly is provided over the processing cup 423. The splash guard 424 has a configuration rotationally symmetric with respect to the rotary shaft 425. A drainage guide groove 441 of a dog-legged sectional configuration is formed annularly in the inner surface of an upper end portion of the splash guard 424. A collected liquid guide portion 442 defined by an outwardly downwardly inclined surface is formed in the inner surface of a lower end portion of the splash guard 424. A partition wall receiving groove 443 for receiving the partition wall 433 in the processing cup 423 is formed near the upper end of the collected liquid guide portion 442.

The splash guard 424 is driven to move upwardly and downwardly in a vertical direction by a guard driving mechanism (not shown) including a ball screw mechanism and the like. The guard driving mechanism moves the splash guard 424 upwardly and downwardly between a collection position in which the collected liquid guide portion 442 surrounds the edge portion of the substrate W held by the spin chuck 421 and a drainage position in which the drainage guide groove 441 surrounds the edge portion of the substrate W held by the spin chuck 421. When the splash guard 424 is in the collection position (the position shown in FIG. 6), the processing liquid splashed from the edge portion of the substrate W is guided by the collected liquid guide portion 442 into the collected liquid space 432, and is then collected through the collection pipe 435. When the splash guard 424 is in the drainage position, on the other hand, the processing liquid splashed from the edge portion of the substrate W is guided by the drainage guide groove 441 into the drainage space 431, and is then drained through the drainage pipe 434. In this manner, the drainage and collection of the processing liquid can be selectively carried out. When hydrofluoric acid is used as the surface preparation liquid, strict atmosphere control is required so as to prevent the atmosphere from leaking out within the apparatus.

Referring again to FIG. 3, the thermal processing tower 41 which is closer to the indexer block 1 includes five hot plates HP7 to HP11 for heating a substrate W up to a predetermined temperature, and cool plates CP10 to CP13 for cooling a heated substrate W down to a predetermined temperature and for maintaining the substrate W at the predetermined temperature. The cool plates CP10 to CP13 and the hot plates HP7 to HP11 are arranged in stacked relation in bottom-to-top order in this thermal processing tower 41.

The thermal processing tower 42 which is farther from the indexer block 1, on the other hand, includes the six heating parts PHP7 to PHP12 and a cool plate CP14 which are arranged in stacked relation. Like the above-mentioned heating parts PHP1 to PHP6, each of the heating parts PHP7 to PHP12 is a thermal processing unit including a temporary substrate rest part and a local transport mechanism.

FIGS. 7A and 7B schematically show the construction of the heating part PHP7 with the temporary substrate rest part. FIG. 7A is a side sectional view of the heating part PHP7, and FIG. 7B is a plan view of the heating part PHP7. Although the heating part PHP7 is shown in FIGS. 7A and 7B, the heating parts PHP8 to PHP12 are precisely identical in construction with the heating part PHP7. The heating part PHP7 includes a heating plate 710 for performing a heating process on a substrate W placed thereon, a temporary substrate rest part 719 for placing a substrate W in an upper or lower position (in this preferred embodiment, an upper position) spaced apart from the heating plate 710, and a local transport mechanism 720 specific to a thermal processing part for transporting a substrate W between the heating plate 710 and the temporary substrate rest part 719. The heating plate 710 is provided with a plurality of movable support pins 721 extendable out of and retractable into the plate surface. A vertically movable top cover 722 for covering a substrate W during the heating process is provided over the heating plate 710. The temporary substrate rest part 719 is provided with a plurality of fixed support pins 723 for supporting a substrate W.

The local transport mechanism 720 includes a holding plate 724 for holding a substrate W in a substantially horizontal position. The holding plate 724 is moved upwardly and downwardly by a screw feed drive mechanism 725, and is moved back and forth by a belt drive mechanism 726. The holding plate 724 is provided with a plurality of slits 724a so as not to interfere with the movable support pins 721 and the fixed support pins 723 when the holding plate 724 moves to over the heating plate 710 and moves into the temporary substrate rest part 719.

The local transport mechanism 720 further includes a cooling element for cooling a substrate W in the course of the transport of the substrate W from the heating plate 710 to the temporary substrate rest part 719. As illustrated in FIG. 7B, the cooling element is constructed so that a cooling water passage 724b through which a cooling water flows is provided inside the holding plate 724. The cooling element may be constructed so that, for example, a Peltier device or the like is provided inside the holding plate 724.

The above-mentioned local transport mechanism 720 is provided at the rear of (i.e., on the (+Y) side relative to) the heating plate 710 and the temporary substrate rest part 719 in the substrate processing apparatus SP. A transport robot TR4 of the interface block 5 is disposed on the (+X) side relative to the heating plate 710 and the temporary substrate rest part 719, and the transport robot TR3 of the development processing block 4 is disposed on the (−Y) side relative to the heating plate 710 and the temporary substrate rest part 719. In an upper portion of an enclosure 727 covering the heating plate 710 and the temporary substrate rest part 719, i.e., a portion of the enclosure 727 which covers the temporary substrate rest part 719, an opening 719a is provided on the (+X) side for allowing the transport robot TR4 to enter the temporary substrate rest part 719, and an opening 719b is provided on the (+Y) side for allowing the local transport mechanism 720 to enter the temporary substrate rest part 719. In a lower portion of the enclosure 727, i.e., a portion of the enclosure 727 which covers the heating plate 710, no openings are provided on the (+X) and (−Y) sides (i.e., the surfaces of the enclosure 727 opposed to the transport robot TR3 and the transport robot TR4), and an opening 719c is provided on the (+Y) side for allowing the local transport mechanism 720 to enter the heating plate 710.

A substrate W is carried into and out of the above-mentioned heating part PHP7 in a manner to be described below. First, the transport robot TR4 of the interface block 5 holds an exposed substrate W, and places the substrate W onto the fixed support pins 723 of the temporary substrate rest part 719. Subsequently, the holding plate 724 of the local transport mechanism 720 moves to under the substrate W, and then moves slightly upwardly to receive the substrate W from the fixed support pins 723. The holding plate 724 which holds the substrate W moves backwardly out of the enclosure 727, and moves downwardly to a position opposed to the heating plate 710. At this time, the movable support pins 721 of the heating plate 710 are in a lowered position, and the top cover 722 is in a raised position. The holding plate 724 which holds the substrate W moves to over the heating plate 710. After the movable support pins 721 move upwardly and receive the substrate W in a receiving position, the holding plate 724 moves backwardly out of the enclosure 727. Subsequently, the movable support pins 721 move downwardly to place the substrate W onto the heating plate 710, and the top cover 722 moves downwardly to cover the substrate W. In this state, the substrate W is subjected to the heating process. After the heating process, the top cover 722 moves upwardly, and the movable support pins 721 move upwardly to lift the substrate W. Next, after the holding plate 724 moves to under the substrate W, the movable support pins 721 move downwardly to transfer the substrate W to the holding plate 724. The holding plate 724 which holds the substrate W moves backwardly out of the enclosure 727, and then moves upwardly to transport the substrate W to the temporary substrate rest part 719. In the course of the transport, the substrate W supported by the holding plate 724 is cooled by the cooling element of the holding plate 724. The holding plate 724 brings the substrate W cooled (to approximately room temperature) onto the fixed support pins 723 of the temporary substrate rest part 719. The transport robot TR4 takes out and transports the substrate W.

The transport robot TR4 transfers and receives the substrate W to and from only the temporary substrate rest part 719, but does not transfer and receive the substrate W to and from the heating plate 710. This avoids the temperature rise of the transport robot TR4. Additionally, the opening 719c through which the substrate W is placed onto and removed from the heating plate 710 is formed only on the side of the local transport mechanism 720. This prevents the heat atmosphere leaking out through the opening 719c from raising the temperatures of the transport robot TR3 and the transport robot TR4 and also from affecting the development processor SD and the cleaning processor SOAK.

As described above, the transport robot TR4 of the interface block 5 can gain access to the heating parts PHP7 to PHP12 and the cool plate CP14, but the transport robot TR3 of the development processing block 4 cannot gain access thereto. The transport robot TR3 of the development processing block 4 gains access to the thermal processing units incorporated in the thermal processing tower 41.

The pair of vertically arranged substrate rest parts PASS7 and PASS8 in proximity to each other for the transfer of a substrate W between the development processing block 4 and the interface block 5 adjacent thereto are incorporated in the topmost tier of the thermal processing tower 42. The upper substrate rest part PASS7 is used for the transport of a substrate W from the development processing block 4 to the interface block 5. Specifically, the transport robot TR4 of the interface block 5 receives the substrate W placed on the substrate rest part PASS7 by the transport robot TR3 of the development processing block 4. The lower substrate rest part PASS8, on the other hand, is used for the transport of a substrate W from the interface block 5 to the development processing block 4. Specifically, the transport robot TR3 of the development processing block 4 receives the substrate W placed on the substrate rest part PASS8 by the transport robot TR4 of the interface block 5. Each of the substrate rest parts PASS7 and PASS8 includes both an open side facing the transport robot TR3 of the development processing block 4 and an open side facing the transport robot TR4 of the interface block 5.

Next, the interface block 5 for connection to the exposure unit EXP will be described. The interface block 5 is a block provided adjacent to the development processing block 4. The interface block 5 receives a substrate W with the resist film formed thereon by the resist coating process from the resist coating block 3 to transfer the substrate W to the exposure unit EXP. Also, the interface block 5 receives an exposed substrate W from the exposure unit EXP to transfer the exposed substrate W to the development processing block 4. The interface block 5 in this preferred embodiment includes a transport mechanism 55 for transferring and receiving a substrate W to and from the exposure unit EXP, a pair of edge exposure units EEW1 and EEW2 for exposing the periphery of a substrate W formed with the resist film, and the transport robot TR4 for transferring and receiving a substrate W to and from the heating parts PHP7 to PHP12 and cool plate CP14 provided in the development processing block 4 and the edge exposure units EEW1 and EEW2.

As shown in FIG. 2, each of the edge exposure units EEW1 and EEW2 (collectively referred to as an edge exposure part EEW, unless otherwise identified) includes a spin chuck 56 for rotating a substrate W in a substantially horizontal plane while holding the substrate W in a substantially horizontal position under suction, a light irradiator 57 for exposing the periphery of the substrate W held on the spin chuck 56 to light, and the like. The pair of edge exposure units EEW1 and EEW2 are arranged in vertically stacked relation in the center of the interface block 5. The transport robot TR4 provided adjacent to the edge exposure part EEW and the thermal processing tower 42 of the development processing block 4 is similar in construction to the above-mentioned transport robots TR1 to TR3.

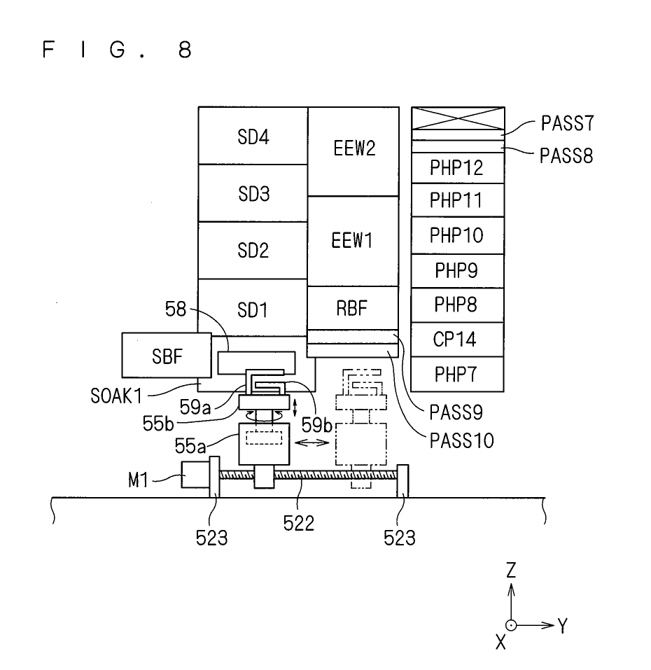

With reference to FIGS. 2 and 8, description will be further continued. FIG. 8 is a side view of the interface block 5 as seen from the (+X) side. A return buffer RBF for the return of substrates W is provided under the pair of edge exposure units EEW1 and EEW2, and the pair of vertically arranged substrate rest parts PASS9 and PASS10 are provided under the return buffer RBF. The return buffer RBF is provided to temporarily store a substrate W subjected to a post-exposure bake process in the heating parts PHP7 to PHP12 of the development processing block 4 if the development processing block 4 is unable to perform the development process on the substrate W because of some sort of malfunction and the like. The return buffer RBF includes a cabinet capable of storing a plurality of substrates W in tiers. The upper substrate rest part PASS9 is used for the transfer of a substrate W from the transport robot TR4 to the transport mechanism 55. The lower substrate rest part PASS10 is used for the transfer of a substrate W from the transport mechanism 55 to the transport robot TR4. The transport robot TR4 gains access to the return buffer RBF.

As shown in FIG. 8, the transport mechanism 55 includes a movable base 55a in threaded engagement with a threaded shaft 522. The threaded shaft 522 is rotatably supported by a pair of support bases 523 so that the rotation axis thereof extends along the Y axis. The threaded shaft 522 has one end coupled to a motor M1. The motor M1 drives the threaded shaft 522 to rotate, thereby moving the movable base 55a horizontally along the Y axis.

A hand support base 55b is mounted on the movable base 55a. The hand support base 55b is movable upwardly and downwardly in a vertical direction (along the Z axis) and is pivotable about a vertical axis by a lifting mechanism and a pivot mechanism incorporated in the movable base 55a. A pair of holding arms 59a and 59b for holding a substrate W is mounted on the hand support base 55b so as to be arranged vertically. The pair of holding arms 59a and 59b are movable back and forth in the direction of the pivot radius of the hand support base 55b independently of each other by a sliding drive mechanism incorporated in the movable base 55a. With such an arrangement, the transport mechanism 55 transfers and receives a substrate W to and from the exposure unit EXP, transfers and receives a substrate W to and from the substrate rest parts PASS9 and PASS10, and stores and takes a substrate W into and out of a send buffer SBF for the sending of substrates W. The send buffer SBF is provided to temporarily store a substrate W prior to the exposure process if the exposure unit EXP is unable to accept the substrate W, and includes a cabinet capable of storing a plurality of substrates W in tiers.

As shown in FIGS. 2 and 8, the cleaning processing unit SOAK1 has an opening 58 on the (+X) side. Thus, the transport mechanism 55 can transfer and receive a substrate W to and from the cleaning processing unit SOAK1 through the opening 58.

A downflow of clean air is always supplied into the indexer block 1, the BARC block 2, the resist coating block 3, the development processing block 4, and the interface block 5 described above to thereby avoid the adverse effects of raised particles and gas flows upon the processes in the blocks 1 to 5. Additionally, a slightly positive pressure relative to the external environment of the substrate processing apparatus SP is maintained in each of the blocks 1 to 5 to prevent the entry of particles and contaminants from the external environment into the blocks 1 to 5.

The indexer block 1, the BARC block 2, the resist coating block 3, the development processing block 4 and the interface block 5 as described above are units into which the substrate processing apparatus SP of this preferred embodiment is divided in mechanical terms. The blocks 1 to 5 are assembled to individual block frames, respectively, which are in turn connected together to construct the substrate processing apparatus SP.

On the other hand, this preferred embodiment employs another type of units, that is, transport control units regarding the transport of substrates, aside from the blocks which are units based on the above-mentioned mechanical division. The transport control units regarding the transport of substrates are referred to herein as “cells.” Each of the cells includes a transport robot responsible for the transport of substrates, and a transport destination part to which the transport robot transports a substrate. Each of the substrate rest parts described above functions as an entrance substrate rest part for the receipt of a substrate W into a cell or as an exit substrate rest part for the transfer of a substrate W out of a cell. The transfer of substrates W between the cells is also carried out through the substrate rest parts. The transport robots constituting the cells include the substrate transfer mechanism 12 of the indexer block 1 and the transport mechanism 55 of the interface block 5.

The substrate processing apparatus SP in this preferred embodiment includes six cells: an indexer cell, a BARC cell, a resist coating cell, a development processing cell, a post-exposure bake cell, and an interface cell. The indexer cell includes the table 11 and the substrate transfer mechanism 12, and is consequently similar in construction to the indexer block 1 which is one of the units based on the mechanical division. The BARC cell includes the bottom coating processor BRC, the pair of thermal processing towers 21 and the transport robot TR1. The BARC cell is also consequently similar in construction to the BARC block 2 which is one of the units based on the mechanical division. The resist coating cell includes the resist coating processor SC, the pair of thermal processing towers 31, and the transport robot TR2. The resist coating cell is also consequently similar in construction to the resist coating block 3 which is one of the units based on the mechanical division. The resist coating cell may be provided with a cover film coating processor for forming a cover film on the resist film so as to prevent the resist from dissolving during the exposure.

The development processing cell includes the development processor SD, the thermal processing tower 41, and the transport robot TR3. Because the transport robot TR3 cannot gain access to the heating parts PHP7 to PHP12 and the cool plate CP14 of the thermal processing tower 42 as discussed above, the development processing cell does not include the thermal processing tower 42. Because the transport mechanism 55 of the interface block 5 gains access to the cleaning processing unit SOAK1 of the cleaning processor SOAK, the cleaning processor SOAK is also not included in the development processing cell. In these respects, the development processing cell differs from the development processing block 4 which is one of the units based on the mechanical division.

The post-exposure bake cell includes the thermal processing tower 42 positioned in the development processing block 4, the edge exposure part EEW positioned in the interface block 5, and the transport robot TR4 positioned in the interface block 5. That is, the post-exposure bake cell extends over the development processing block 4 and the interface block 5 which are units based on the mechanical division. In this manner, constituting one cell including the heating parts PHP7 to PHP12 for performing the post-exposure bake process and the transport robot TR4 allows the rapid transport of exposed substrates W into the heating parts PHP7 to PHP12 for the execution of the thermal process. Such an arrangement is preferred for the use of a chemically amplified resist which is required to be subjected to a heating process as soon as possible after the exposure of a substrate W in a pattern.

The substrate rest parts PASS7 and PASS8 included in the thermal processing tower 42 are provided for the transfer of a substrate W between the transport robot TR3 of the development processing cell and the transport robot TR4 of the post-exposure bake cell.

The interface cell includes the transport mechanism 55 for transferring and receiving a substrate W to and from the exposure unit EXP, and the cleaning processor SOAK. The interface cell has a construction different from that of the interface block 5 which is one of the units based on the mechanical division in that the interface cell includes the cleaning processor SOAK positioned in the development processing block 4 and does not include the transport robot TR4 and the edge exposure part EEW. The substrate rest parts PASS9 and PASS10 under the edge exposure part EEW are provided for the transfer of a substrate W between the transport robot TR4 of the post-exposure bake cell and the transport mechanism 55 of the interface cell.

Next, the exposure unit EXP will be described. The exposure unit EXP performs the exposure process on a substrate W resist-coated in the substrate processing apparatus SP. The exposure unit EXP according to this preferred embodiment is an immersion exposure apparatus compatible with an “immersion exposure processing method” which substantially shortens the wavelength of exposure light to improve resolution and to substantially widen the depth of focus. The exposure unit EXP performs the exposure process, with the space between a projection optical system and the substrate W filled with a liquid having a high refractive index (e.g., deionized water having a refractive index n=1.44).

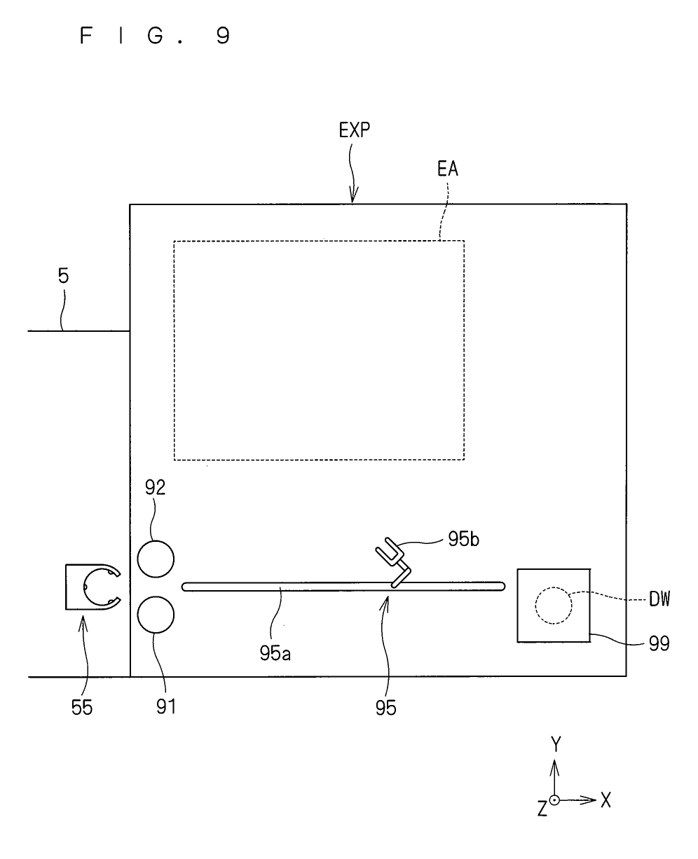

FIG. 9 is a schematic plan view showing the construction of the exposure unit EXP connected in adjacent relation to the substrate processing apparatus SP. The process of exposing a substrate W is carried out in an exposure area EA within the exposure unit EXP. Mechanisms for the immersion exposure process are disposed in the exposure area EA. Examples of such mechanisms include an illumination optical system, a projection optical system, a mask stage, a substrate stage, a stage movement mechanism, a liquid supply mechanism, and a liquid collecting mechanism (all of which are not shown). A transport mechanism 95 for transporting a substrate W is provided within the exposure unit EXP. The transport mechanism 95 includes a bendable arm portion 95b, and a guide portion 95a for guiding the arm portion 95b. The arm portion 95b moves along the guide portion 95a.

A pair of tables 91 and 92 are provided near a side portion of the exposure unit EXP in contact with the interface block 5 of the substrate processing apparatus SP. The substrate processing apparatus SP and the exposure unit EXP are connected to each other so that the transport mechanism 55 of the interface block 5 is capable of transferring and receiving a substrate W to and from the tables 91 and 92. The table 91 is used for the transfer of an exposed substrate W, and the table 92 is used for the transfer of an unexposed substrate W. In addition to the transport mechanism 95, a transfer mechanism not shown for transferring and receiving a substrate W directly to and from the exposure area EA is also provided within the exposure unit EXP. The transport mechanism 95 passes a resist-coated substrate W received from the table 92 to this transfer mechanism, and places an exposed substrate W received from the transfer mechanism onto the table 91.

A housing portion 99 for housing a dummy substrate DW is provided in the exposure unit EXP. The dummy substrate DW is used in the immersion-compatible exposure unit EXP to prevent deionized water from entering the inside of the substrate stage during an alignment process for adjusting the exposure position of a pattern image, such as stage position calibration and the like. The dummy substrate DW is approximately identical in shape and size with a normal substrate W (for semiconductor device fabrication). The material of the dummy substrate DW may be the same as that of the normal substrate W (for example, silicon), but is required only to prevent contaminants from dissolving out in a liquid during the immersion exposure process. The dummy substrate DW may have a surface made water-repellent. An example of the technique of making the surface of the dummy substrate DW water-repellent is a coating process using a water-repellent material such as a fluorine compound, a silicon compound, acrylic resin, polyethylene and the like. Alternatively, the dummy substrate DW itself may be made of the above-mentioned water-repellent materials. When the alignment process is not performed, e.g. when the normal exposure process is performed, the dummy substrate DW is unnecessary and therefore is held in the housing portion 99. The housing portion 99 may have a multi-tier cabinet structure capable of storing a plurality of dummy substrates DW.

The transport mechanism 95 transports the dummy substrate DW into and out of the housing portion 99. Specifically, the arm portion 95b moved to one end of the guide portion 95a which is on the (+X) side makes upward and downward movements and bending and stretching movements to thereby transport the dummy substrate DW into and out of the housing portion 99. Also, the transport mechanism 95 transports the dummy substrate DW between the housing portion 99 and the substrate processing apparatus SP. Specifically, the transport mechanism 95 transports the dummy substrate DW taken out of the housing portion 99 to the table 91 to place the dummy substrate DW onto the table 91, and transports the dummy substrate DW placed on the table 92 to the housing portion 99 to house the dummy substrate DW into the housing portion 99. The transport mechanism 55 of the substrate processing apparatus SP is capable of receiving the dummy substrate DW placed on the table 91, and of placing the dummy substrate DW held thereon onto the table 92.

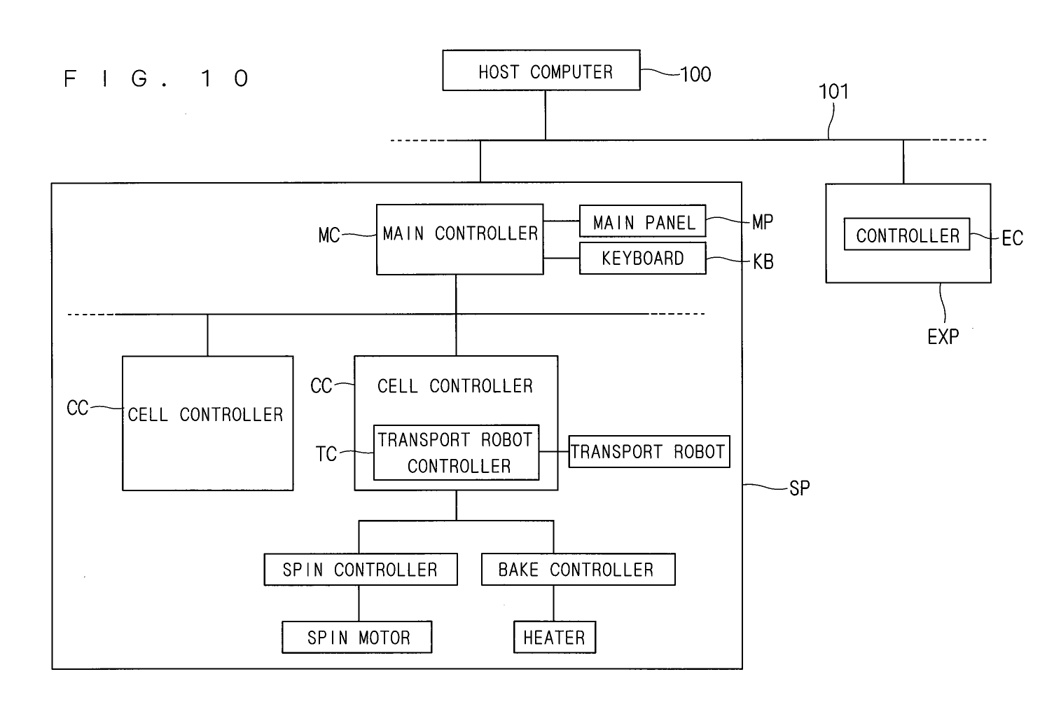

Next, a control mechanism for a substrate processing system according to this preferred embodiment will be described. FIG. 10 is a schematic block diagram of the control mechanism for the substrate processing system according to the present invention. As shown in FIG. 10, the substrate processing apparatus SP and the exposure unit EXP are connected to each other through the host computer 100 and a LAN line 101. The substrate processing apparatus SP has a three-level control hierarchy composed of a main controller MC, cell controllers CC, and unit controllers. The main controller MC, the cell controllers CC and the unit controllers are similar in hardware construction to typical computers. Specifically, each of the controllers includes a CPU for performing various computation processes, a ROM or read-only memory for storing a basic program therein, a RAM or readable/writable memory for storing various pieces of information therein, a magnetic disk for storing control applications and data therein, and the like.

The single main controller MC at the first level is provided for the entire substrate processing apparatus SP, and is principally responsible for the management of the entire substrate processing apparatus SP, the management of a main panel MP, and the management of the cell controllers CC. The main panel MP functions as a display for the main controller MC. Various commands and parameters may be entered into the main controller MC from a keyboard KB. The main panel MP may be in the form of a touch panel so that a user performs an input process into the main controller MC from the main panel MP.

The cell controllers CC at the second level are individually provided in corresponding relation to the six cells (the indexer cell, the BARC cell, the resist coating cell, the development processing cell, the post-exposure bake cell, and the interface cell). Each of the cell controllers CC is principally responsible for the control of the transport of substrates and the management of the units in a corresponding cell. Specifically, the cell controllers CC for the respective cells send and receive information in such a manner that a first cell controller CC for a first cell sends information indicating that a substrate W is placed on a predetermined substrate rest part to a second cell controller CC for a second cell adjacent to the first cell, and the second cell controller CC for the second cell having received the substrate W sends information indicating that the substrate W is received from the predetermined substrate rest part back to the first cell controller CC. Such sending and receipt of information are carried out through the main controller MC. Each of the cell controllers CC provides the information indicating that a substrate W is transported into a corresponding cell to a transport robot controller TC, which in turn controls a corresponding transport robot to circulatingly transport the substrate W in the corresponding cell in accordance with a predetermined procedure. The transport robot controller TC is a controller implemented by the operation of a predetermined application in the corresponding cell controller CC.

Examples of the unit controllers at the third level include a spin controller and a bake controller. The spin controller directly controls the spin units (the coating processing units, the development processing units and the cleaning processing unit) provided in a corresponding cell in accordance with an instruction given from a corresponding cell controller CC. Specifically, the spin controller controls, for example, a spin motor for a spin unit to adjust the number of revolutions of a substrate W. The bake controller directly controls the thermal processing units (the hot plates, the cool plates, the heating parts, and the like) provided in a corresponding cell in accordance with an instruction given from a corresponding cell controller CC. Specifically, the bake controller controls, for example, a heater incorporated in a hot plate to adjust a plate temperature and the like.

The exposure unit EXP, on the other hand, is provided with a controller EC which is a separate controller independent of the above-mentioned control mechanism of the substrate processing apparatus SP. In other words, the exposure unit EXP does not operate under the control of the main controller MC of the substrate processing apparatus SP, but controls its own operation alone. The controller EC for the exposure unit EXP is similar in hardware construction to a typical computer. The controller EC controls the exposure process in the exposure area EA, and also controls the operation of the transport mechanism 95.

The host computer 100 ranks as a higher level control mechanism than the three-level control hierarchy provided in the substrate processing apparatus SP and than the controller EC for the exposure unit EXP. The host computer 100 includes a CPU for performing various computation processes, a ROM or read-only memory for storing a basic program therein, a RAM or readable/writable memory for storing various pieces of information therein, a magnetic disk for storing control applications and data therein, and the like. The host computer 100 is similar in construction to a typical computer. Typically, a plurality of substrate processing apparatuses SP and a plurality of exposure units EXP according to this preferred embodiment are connected to the host computer 100. The host computer 100 provides a recipe containing descriptions about a processing procedure and processing conditions to each of the substrate processing apparatuses SP and the exposure units EXP connected thereto. The recipe provided from the host computer 100 is stored in a storage part (e.g., a memory) of the main controller MC of each of the substrate processing apparatuses SP and the controller EC of each of the exposure units EXP.

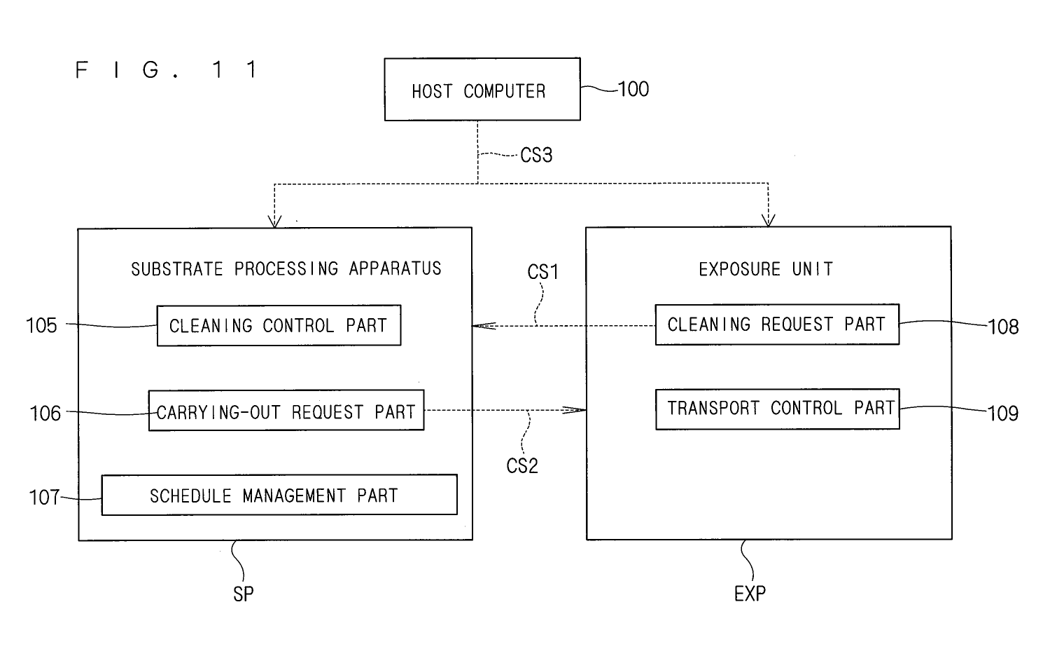

FIG. 11 is a functional block diagram showing functional processing parts implemented in the substrate processing system according to the present invention. A cleaning control part 105, a carrying-out request part 106, and a schedule management part 107 are functional processing parts implemented by the main controller MC of the substrate processing apparatus SP executing predetermined application software. Similarly, a cleaning request part 108 and a transport control part 109 are functional processing parts implemented by the controller EC of the exposure unit EXP executing predetermined application software. The details of the functions of the respective functional processing parts will be described later. At least one or all of the cleaning control part 105, the carrying-out request part 106 and the schedule management part 107 may be implemented by the cell controller CC of the interface cell of the substrate processing apparatus SP.

Next, the operation of the substrate processing apparatus SP of this preferred embodiment will be described. First, brief description will be given on a procedure for the circulating transport of a normal substrate W in the substrate processing apparatus SP. The processing procedure to be described below is in accordance with the descriptions of the recipe received from the host computer 100.

First, unprocessed substrates W stored in a cassette C are transported from the outside of the substrate processing apparatus SP into the indexer block 1 by an AGV (automatic guided vehicle) and the like. Subsequently, the unprocessed substrates W are transferred outwardly from the indexer block 1. Specifically, the substrate transfer mechanism 12 in the indexer cell (or the indexer block 1) takes an unprocessed substrate W out of a predetermined cassette C, and places the unprocessed substrate W onto the substrate rest part PASS1. After the unprocessed substrate W is placed on the substrate rest part PASS1, the transport robot TR1 of the BARC cell uses one of the holding arms 6a and 6b to receive the unprocessed substrate W. The transport robot TR1 transports the received unprocessed substrate W to one of the coating processing units BRC1 to BRC3. In the coating processing units BRC1 to BRC3, the substrate W is spin-coated with the coating solution for the anti-reflective film.

After the completion of the coating process, the transport robot TR1 transports the substrate W to one of the hot plates HP1 to HP6. Heating the substrate W in the hot plate dries the coating solution to form the anti-reflective film serving as the undercoat on the substrate W. Thereafter, the transport robot TR1 takes the substrate W from the hot plate, and transports the substrate W to one of the cool plates CP1 to CP3, which in turn cools down the substrate W. In this step, one of the cool plates WCP may be used to cool down the substrate W. The transport robot TR1 places the cooled substrate W onto the substrate rest part PASS3.

Alternatively, the transport robot TR1 may be adapted to transport the unprocessed substrate W placed on the substrate rest part PASS1 to one of the adhesion promotion processing parts AHL1 to AHL3. In the adhesion promotion processing parts AHL1 to AHL3, the substrate W is thermally processed in a vapor atmosphere of HMDS, whereby the adhesion of the resist film to the substrate W is promoted. The transport robot TR1 takes out the substrate W subjected to the adhesion promotion process, and transports the substrate W to one of the cool plates CP1 to CP3, which in turn cools down the substrate W. Because no anti-reflective film is to be formed on the substrate W subjected to the adhesion promotion process, the cooled substrate W is directly placed onto the substrate rest part PASS3 by the transport robot TR1.

A dehydration process may be performed prior to the application of the coating solution for the anti-reflective film. In this case, the transport robot TR1 transports the unprocessed substrate W placed on the substrate rest part PASS1 first to one of the adhesion promotion processing parts AHL1 to AHL3. In the adhesion promotion processing parts AHL1 to AHL3, a heating process (dehydration bake) merely for dehydration is performed on the substrate W without supplying the vapor atmosphere of HMDS. The transport robot TR1 takes out the substrate W subjected to the heating process for dehydration, and transports the substrate W to one of the cool plates CP1 to CP3, which in turn cools down the substrate W. The transport robot TR1 transports the cooled substrate W to one of the coating processing units BRC1 to BRC3. In the coating processing units BRC1 to BRC3, the substrate W is spin-coated with the coating solution for the anti-reflective film. Thereafter, the transport robot TR1 transports the substrate W to one of the hot plates HP1 to HP6. Heating the substrate W in the hot plate forms the anti-reflective film serving as the undercoat on the substrate W. Thereafter, the transport robot TR1 takes the substrate W from the hot plate, and transports the substrate W to one of the cool plates CP1 to CP3, which in turn cools down the substrate W. Then, the transport robot TR1 places the cooled substrate W onto the substrate rest part PASS3.

After the substrate W is placed on the substrate rest part PASS3, the transport robot TR2 of the resist coating cell receives the substrate W, and transports the substrate W to one of the coating processing units SC1 to SC3. In the coating processing units SC1 to SC3, the substrate W is spin-coated with the resist. Because the resist coating process requires precise substrate temperature control, the substrate W may be transported to one of the cool plates CP4 to CP9 immediately before being transported to the coating processing units SC1 to SC3.

After the completion of the resist coating process, the transport robot TR2 transports the substrate W to one of the heating parts PHP1 to PHP6. In the heating parts PHP1 to PHP6, heating the substrate W removes a solvent component from the resist to form a resist film on the substrate W. Thereafter, the transport robot TR2 takes the substrate W from the one of the heating parts PHP1 to PHP6, and transports the substrate W to one of the cool plates CP4 to CP9, which in turn cools down the substrate W. Then, the transport robot TR2 places the cooled substrate W onto the substrate rest part PASS5.

After the substrate W with the resist film formed thereon by the resist coating process is placed on the substrate rest part PASS5, the transport robot TR3 of the development processing cell receives the substrate W, and places the substrate W onto the substrate rest part PASS7 without any processing of the substrate W. Then, the transport robot TR4 of the post-exposure bake cell receives the substrate W placed on the substrate rest part PASS7, and transports the substrate W into one of the edge exposure units EEW1 and EEW2. In the edge exposure units EEW1 and EEW2, a peripheral edge portion of the substrate W is exposed to light. The transport robot TR4 places the substrate W subjected to the edge exposure process onto the substrate rest part PASS9. The transport mechanism 55 of the interface cell receives the substrate W placed on the substrate rest part PASS9, and transports the substrate W into the exposure unit EXP. In this step, the transport mechanism 55 uses the holding arm 59a to transport the substrate W from the substrate rest part PASS9 to the table 92 of the exposure unit EXP. The resist-coated substrate W placed on the table 92 is brought into the exposure area EA via the transport mechanism 95, and is then subjected to the pattern exposure process.

Because the chemically amplified resist is used in this preferred embodiment, an acid is formed by a photochemical reaction in the exposed portion of the resist film formed on the substrate W. In the exposure unit EXP, the substrate W is subjected to the immersion exposure process. This achieves a high resolution with virtually no change of the conventional light source and exposure process. The substrate W subjected to the edge exposure process may be transported to the cool plate CP14 for the cooling process by the transport robot TR4 before being transported into the exposure unit EXP.

The exposed substrate W subjected to the pattern exposure process is transported via the transport mechanism 95 to the table 91. The transport mechanism 55 takes out the substrate W placed on the table 91, whereby the substrate W is returned from the exposure unit EXP to the interface cell again. Thereafter, the transport mechanism 55 transports the exposed substrate W into the cleaning processing unit SOAK1. In this step, the transport mechanism 55 uses the holding arm 59b to transport the substrate W from the exposure unit EXP to the cleaning processing unit SOAK1. There are cases where a liquid adheres to the substrate W subjected to the immersion exposure process. However, the holding arm 59a is used for the transport of the unexposed substrate W and the holding arm 59b is exclusively used for the transport of the exposed substrate W. This avoids the adhesion of the liquid to at least the holding arm 59a, to prevent the transfer of the liquid to the unexposed substrate W.

The process of cleaning the substrate W by using the cleaning processing nozzle 450, and the process of drying the substrate W by using the drying processing nozzle 451 are performed in the cleaning processing unit SOAK1. The transport mechanism 55 takes the substrate W subjected to the cleaning and drying processes out of the cleaning processing unit SOAK1, and places the substrate W onto the substrate rest part PASS10. In this step, the transport mechanism 55 uses the holding arm 59a to transport the substrate W from the cleaning processing unit SOAK1 to the substrate rest part PASS10. After the exposed substrate W is placed on the substrate rest part PASS10, the transport robot TR4 of the post-exposure bake cell receives the substrate W, and transports the substrate W to one of the heating parts PHP7 to PHP12. The processing operation in the heating parts PHP7 to PHP12 is as described above. In the heating parts PHP7 to PHP12, the heating process (or the post-exposure bake process) is performed which causes a reaction such as crosslinking, polymerization and the like of the resist resin to proceed by using a product formed by the photochemical reaction during the exposure process as an acid catalyst, thereby locally changing the solubility of only an exposed portion of the resist resin in the developing solution. The local transport mechanism 720 having the cooling mechanism transports the substrate W subjected to the post-exposure bake process to thereby cool down the substrate W, whereby the above-mentioned chemical reaction stops. Subsequently, the transport robot TR4 takes the substrate W from the one of the heating parts PHP7 to PHP12, and places the substrate W onto the substrate rest part PASS8.

After the substrate W is placed on the substrate rest part PASS8, the transport robot TR3 of the development processing cell receives the substrate W, and transports the substrate W to one of the cool plates CP10 to CP13. In the cool plates CP10 to CP13, the substrate W subjected to the post-exposure bake process is further cooled down and precisely controlled at a predetermined temperature. Thereafter, the transport robot TR3 takes the substrate W from the one of the cool plates CP10 to CP13, and transports the substrate W to one of the development processing units SD1 to SD4. In the development processing units SD1 to SD4, the developing solution is applied onto the substrate W to cause the development process to proceed. After the completion of the development process, the transport robot TR3 transports the substrate W to one of the hot plates HP7 to HP11, and then transports the substrate W to one of the cool plates CP10 to CP13.

Thereafter, the transport robot TR3 places the substrate W onto the substrate rest part PASS6. The transport robot TR2 of the resist coating cell places the substrate W from the substrate rest part PASS6 onto the substrate rest part PASS4 without any processing of the substrate W. Next, the transport robot TR1 of the BARC cell places the substrate W from the substrate rest part PASS4 onto the substrate rest part PASS2 without any processing of the substrate W, whereby the substrate W is stored in the indexer block 1. Then, the substrate transfer mechanism 12 of the indexer cell stores the processed substrate W held on the substrate rest part PASS2 into a predetermined cassette C. Thereafter, the cassette C in which a predetermined number of processed substrates W are stored is transported to the outside of the substrate processing apparatus SP. Thus, a series of photolithography processes are completed.

As discussed above, the exposure unit EXP according to this preferred embodiment is provided to perform the immersion exposure process, and uses a dummy substrate DW to prevent deionized water from entering the inside of the substrate stage during the alignment process for adjusting the exposure position of the pattern image. Specifically, the dummy substrate DW is fitted in a recessed stage portion of the substrate stage for the execution of the alignment process. This prevents the liquid from entering the inside of the substrate stage, but creates a likelihood that the liquid adheres to the dummy substrate DW to remain in the form of droplets on the dummy substrate DW. When left unremoved, such droplets dry to become a source of contamination or impair the water repellency of the dummy substrate DW, as mentioned above.

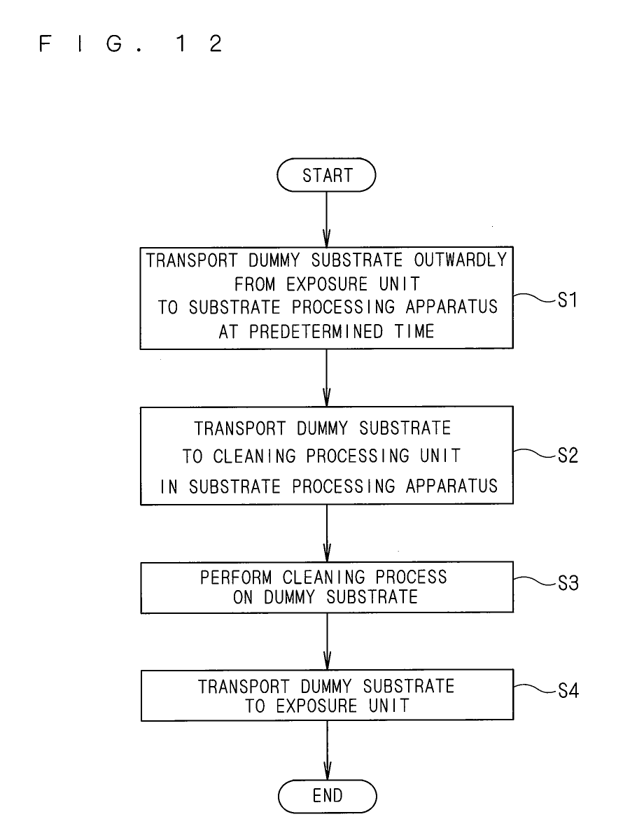

This preferred embodiment avoids such problems by cleaning the dummy substrate DW possessed by the exposure unit EXP in the substrate processing apparatus SP. FIG. 12 is a flow chart showing a procedure for cleaning of the dummy substrate DW. First, the dummy substrate DW is transported outwardly from the exposure unit EXP to the substrate processing apparatus SP at a predetermined time (in Step S1). The predetermined time may be immediately before or immediately after the above-mentioned alignment process (exposure position adjustment) in the exposure unit EXP. The predetermined time may also be immediately before and immediately after the alignment process, or may be other times to be described later. When the dummy substrate DW is transported to the substrate processing apparatus SP and cleaned in the substrate processing apparatus SP immediately before the alignment process, the alignment process can be performed by using the clean dummy substrate DW. When the dummy substrate DW is transported to the substrate processing apparatus SP and cleaned in the substrate processing apparatus SP immediately after the alignment process, the cleaning process can be performed before the droplets adhering to the dummy substrate DW during the alignment process dry to become a source of contamination. When transporting the dummy substrate DW outwardly from the exposure unit EXP immediately before the alignment process, the transport mechanism 95 takes the dummy substrate DW out of the housing portion 99 and places the dummy substrate DW onto the table 91. When transporting the dummy substrate DW outwardly from the exposure unit EXP immediately after the alignment process, the transport mechanism 95 receives the dummy substrate DW just processed from the exposure area EA and directly places the dummy substrate DW onto the table 91.

The transport mechanism 55 takes the dummy substrate DW placed on the table 91 out of the exposure unit EXP into the substrate processing apparatus SP, and transports the dummy substrate DW to the cleaning processing unit SOAK1 (in Step S2). Then, the cleaning process is performed on the dummy substrate DW in the cleaning processing unit SOAK1 (in Step S3).

The processing operation in the cleaning processing unit SOAK1 will be described. When the dummy substrate DW is transported into the cleaning processing unit SOAK1, the splash guard 424 is moved downwardly, and the transport mechanism 55 places the dummy substrate DW onto the spin chuck 421. The dummy substrate DW placed on the spin chuck 421 is held in a horizontal position under suction by the spin chuck 421.

Next, the splash guard 424 moves to the above-mentioned drainage position, and the cleaning processing nozzle 450 moves to over the center of the dummy substrate DW. Thereafter, the rotary shaft 425 starts rotating. As the rotary shaft 425 rotates, the dummy substrate DW held by the spin chuck 421 is rotated. Thereafter, the valve Va is opened to apply the cleaning liquid from the cleaning processing nozzle 450 onto the upper surface of the dummy substrate DW. In this case, deionized water is applied as the cleaning liquid to the dummy substrate DW. Thus, the process of cleaning the dummy substrate DW proceeds to wash away the liquid for immersion exposure from the dummy substrate DW. The liquid splashed from the rotating dummy substrate DW by centrifugal force is guided by the drainage guide groove 441 into the drainage space 431, and is drained through the drainage pipe 434.

After a lapse of a predetermined time period, the speed of rotation of the rotary shaft 425 decreases. This decreases the amount of deionized water spattered by the rotation of the dummy substrate DW to form a film of deionized water on the entire surface of the dummy substrate DW in such a manner that a puddle of deionized water remains on the dummy substrate DW. Alternatively, a film of deionized water may be formed on the entire surface of the dummy substrate DW by stopping the rotation of the rotary shaft 425.

Next, the supply of the deionized water serving as the cleaning liquid is stopped. The cleaning processing nozzle 450 is retracted to a predetermined position, and the drying processing nozzle 451 moves to over the center of the dummy substrate DW. Thereafter, the valve Vc is opened to apply an inert gas from the drying processing nozzle 451 to near the center of the upper surface of the dummy substrate DW. In this preferred embodiment, nitrogen gas is applied as the inert gas. Thus, the water or moisture in the center of the dummy substrate DW is forced toward the peripheral edge portion of the dummy substrate DW. As a result, the film of deionized water remains only in the peripheral edge portion of the dummy substrate DW.

Next, the speed of rotation of the rotary shaft 425 increases again, and the drying processing nozzle 451 gradually moves from over the center of the dummy substrate DW toward over the peripheral edge portion of the dummy substrate DW. Thus, a great centrifugal force is exerted on the film of deionized water remaining on the dummy substrate DW, and the inert gas can impinge on the entire surface of the dummy substrate DW, whereby the film of deionized water on the dummy substrate DW is reliably removed. As a result, the dummy substrate DW is dried with reliability.

Next, the supply of the inert gas is stopped. The drying processing nozzle 451 is retracted to a predetermined position, and the rotation of the rotary shaft 425 is stopped. Thereafter, the splash guard 424 is moved downwardly, and the transport mechanism 55 transports the dummy substrate DW out of the cleaning processing unit SOAK1. This completes the processing operation in the cleaning processing unit SOAK1. The position of the splash guard 424 during the cleaning and drying processes is preferably appropriately changed depending on the need for the collection and drainage of the processing liquid. The cleaning of the normal exposed substrate W in the cleaning processing unit SOAK1 is performed in a manner similar to that of the dummy substrate DW.

The transport mechanism 55 transports the dummy substrate DW subjected to the cleaning and drying processes in the cleaning processing unit SOAK1 to the exposure unit EXP (in Step S4), and places the dummy substrate DW onto the table 92. When the above-mentioned cleaning process is performed immediately after the alignment process, the transport mechanism 95 houses the dummy substrate DW placed on the table 92 into the housing portion 99. When the above-mentioned cleaning process is performed immediately before the alignment process, the transport mechanism 95 transfers the dummy substrate DW placed on the table 92 to the exposure area EA. When the exposure unit EXP possesses a plurality of dummy substrates W, the above-mentioned cleaning process is performed on all of the dummy substrates W.

In this way, if the liquid adheres to the dummy substrate DW during the alignment process in the exposure unit EXP, the dummy substrate DW is transported to the substrate processing apparatus SP and cleaned in the substrate processing apparatus SP. This prevents the dummy substrate DW from being contaminated. The dummy substrate DW subjected to the cleaning is returned to the exposure unit EXP, and the clean dummy substrate DW is used for the execution of the alignment process in the exposure unit EXP. This reduces the contamination of the mechanisms in the exposure unit EXP, such as the substrate stage.

When the dummy substrate DW is water-repellent, there are cases where the water repellency of the dummy substrate DW is impaired due to contamination. However, the removal of the contaminants by the above-mentioned cleaning process restores the water repellency of the substrate surface. As a result, the dummy substrate DW can hold the immersion liquid with reliability also during the alignment process. This also significantly reduces the costs, as compared with the process of replacing dummy substrates DW made less water-repellent one by one.

The substrate processing apparatus SP and the exposure unit EXP effect the operation control independent of each other as mentioned above. For the cleaning of the dummy substrate DW, it is hence necessary to previously transmit information about the start of the dummy substrate cleaning to the substrate processing apparatus SP and the exposure unit EXP. In this preferred embodiment, the cleaning request part 108 in the exposure unit EXP transmits a cleaning request signal CS1 to the substrate processing apparatus SP, as shown in FIG. 11. Specifically, the controller EC of the exposure unit EXP transmits the cleaning request signal CS1 immediately before and/or immediately after the alignment process. In the substrate processing apparatus SP which has received the cleaning request signal CS1, the cleaning control part 105 controls and causes the transport mechanism 55 and the cleaning processing unit SOAK1 to perform the cleaning process on the dummy substrate DW. In other words, the exposure unit EXP having judged that it is necessary to clean the dummy substrate DW issues a cleaning request to the substrate processing apparatus SP.

While the preferred embodiment according to the present invention is described hereinabove, various changes and modifications other than those described above may be made therein without departing from the spirit of the invention. For example, although the cleaning request is issued from the exposure unit EXP in the above-mentioned preferred embodiment, the cleaning request may be issued contrarily from the substrate processing apparatus SP. Specifically, the carrying-out request part 106 in the substrate processing apparatus SP transmits to the exposure unit EXP a carrying-out request signal CS2 requesting the exposure unit EXP to transport the dummy substrate DW outwardly therefrom (FIG. 11). In the exposure unit EXP which has received the carrying-out request signal CS2, the transport control part 109 controls and causes the transport mechanism 95 to transport the dummy substrate DW to the substrate processing apparatus SP.

Alternatively, an instruction for cleaning the dummy substrate DW may be given from the host computer 100 ranking as the higher level controller. Specifically, the host computer 100 transmits a cleaning start signal CS3 to both the substrate processing apparatus SP and the exposure unit EXP. In the exposure unit EXP which has received the cleaning start signal CS3, the transport control part 109 controls and causes the transport mechanism 95 to transport the dummy substrate DW to the substrate processing apparatus SP. In the substrate processing apparatus SP which has received the cleaning start signal CS3, on the other hand, the cleaning control part 105 controls and causes the transport mechanism 55 and the cleaning processing unit SOAK1 to perform the cleaning process on the dummy substrate DW.

The time to perform the cleaning process on the dummy substrate DW is not limited to an instant immediately before and/or immediately after the alignment process. For example, the substrate processing system may be scheduled to perform the cleaning process on the dummy substrate DW at predetermined regular time intervals. Specifically, as shown in FIG. 11, the substrate processing apparatus SP includes the schedule management part 107 which causes the carrying-out request part 106 to transmit the carrying-out request signal CS2 at regular time intervals, and causes the transport control part 109 and the cleaning control part 105 to perform the cleaning process on the dummy substrate DW at regular time intervals. Of course, the schedule management part 107 may be provided in the host computer 100 or in the exposure unit EXP.

The time to perform the cleaning process on the dummy substrate DW at regular time intervals may be, for example, the time of regular maintenance of the substrate processing system. The execution of the cleaning process on the dummy substrate DW as one of the maintenance processes at the time of regular maintenance eliminates the apprehension of interference with the photolithography process of normal substrates, to thereby facilitate the control of the cleaning and transport. However, the execution of the cleaning process on the dummy substrate DW immediately before the alignment process allows the execution the alignment process using the cleaner dummy substrate DW obtained immediately after the cleaning. The execution of the cleaning process on the dummy substrate DW immediately after the alignment process ensures the removal of a source of contamination before the adhering liquid dries.

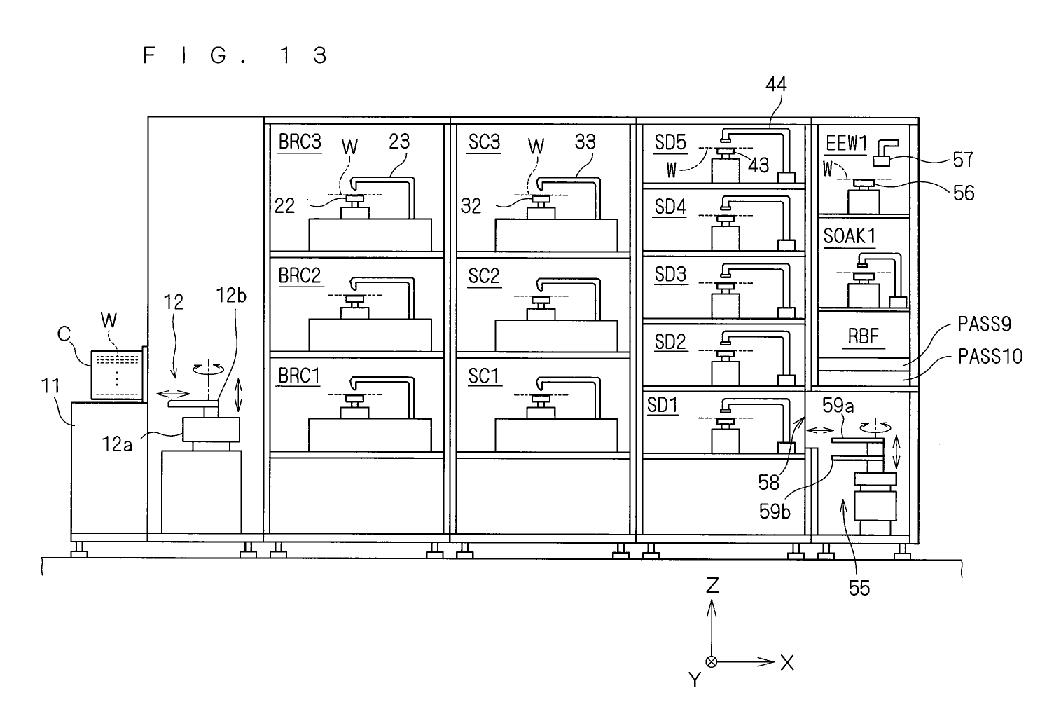

The cleaning processing unit SOAK1 for cleaning the dummy substrate DW is disposed in the development processing block 4 in the above-mentioned preferred embodiment, but may be disposed in the interface block 5. FIG. 13 is a view showing an instance in which the cleaning processing unit SOAK1 is disposed in the interface block 5. Components identical with those of FIG. 2 are designated by like reference numerals and characters. In the instance shown in FIG. 13, five development processing units SD1, SD2, SD3, SD4 and SD5 are disposed in the development processing block 4, and the cleaning processing unit SOAK1 is disposed under the edge exposure unit EEW1 in stacked relation in the interface block 5. That is, one of the two edge exposure units EEW1 and EEW2 shown in FIG. 2 is removed, and the cleaning processing unit SOAK1 is disposed in the resultant space. The transport mechanism 55 transfers and receives the substrate W and the dummy substrate DW directly to and from the cleaning processing unit SOAK1 disposed in the interface block 5.

With the arrangement shown in FIG. 13, the lithography process of the substrate W and the cleaning process of the dummy substrate DW are similar in operation to those of the above-mentioned preferred embodiment. This arrangement also achieves the cleaning of the dummy substrate DW in the exposure unit EXP to reduce the contamination of the mechanisms in the exposure unit EXP such as the substrate stage, as in the above-mentioned preferred embodiment. The provision of the cleaning processing unit SOAK1 in the interface block 5 facilitates the transport control in the entire substrate processing apparatus SP because the interface block 5 serving as a unit based on the mechanical division can accommodate the interface cell serving as a transport control unit entirely.

The surface preparation may be done by supplying a chemical solution to the dummy substrate DW in place of performing the cleaning process on the dummy substrate DW in the cleaning processing unit SOAK1 or after performing the cleaning process. An example of the chemical solution to be supplied in the cleaning processing unit SOAK1 includes hydrofluoric acid. When the dummy substrate DW is a silicon wafer as well as the normal substrate W, a silicon oxide film (a native oxide film) is formed on the surface of the dummy substrate DW to make the surface hydrophilic. The supply of hydrofluoric acid serving as the chemical solution to the surface of the dummy substrate DW removes the silicon oxide film to expose a silicon body, thereby making the surface of the dummy substrate DW water-repellent. That is, the supply of the chemical solution imparts (or restores) the water repellency to the surface of the dummy substrate DW. Specifically, while the dummy substrate DW held by the spin chuck 421 is rotated, the valve Vb is opened to feed hydrofluoric acid from the surface preparation liquid supply source R2 through the cleaning processing nozzle 450 onto the upper surface of the dummy substrate DW. The chemical solution supplied to the dummy substrate DW is not limited to hydrofluoric acid. Depending on the materials of the dummy substrate DW, such a material as a fluorine compound, acrylic resin and the like, for example, may be supplied to the dummy substrate DW to perform a coating process for making the surface of the dummy substrate DW water-repellent in the cleaning processing unit SOAK1. When the chemical solution such as hydrofluoric acid is supplied in the cleaning processing unit SOAK1, strict atmosphere control is required so as to prevent the atmosphere from leaking out of the cleaning processing unit SOAK1.

The cleaning processing unit SOAK1 for cleaning the normal substrate W is also used to perform the cleaning process on the dummy substrate DW in the above-mentioned preferred embodiment. However, cleaning processing units designed specifically for the normal and dummy substrates W and DW, respectively, may be provided. For example, the cleaning processing units may be provided in the development processing block 4 and in the interface block 5, respectively; one of the cleaning processing units being used for cleaning the normal substrate W, the other being used only for the cleaning process of the dummy substrate DW. In particular, the substrate W coated with a chemically amplified resist, immediately after the exposure, is highly susceptible to an alkaline atmosphere. Thus, when the process of supplying a chemical solution is performed in a cleaning processing unit, it is preferable to provide another cleaning processing unit designed specifically for the dummy substrate DW.

Aside from the dummy substrate DW, a cleaning substrate for cleaning use only may be prepared in the exposure unit EXP to clean the substrate stage of the exposure area EA, and be cleaned in the substrate processing apparatus SP. The cleaning substrate is similar to the dummy substrate DW, and is housed in the housing portion 99 of the exposure unit EXP separately from the dummy substrate DW. Like the dummy substrate DW, the cleaning substrate is transported to the cleaning processing unit SOAK1 of the substrate processing apparatus SP at an appropriate time and is cleaned therein. This cleaning process is performed in exactly the same manner as the cleaning process of the dummy substrate DW described in the above-mentioned preferred embodiment. During the process of cleaning the substrate stage in the exposure unit EXP, deionized water similar to that used during the alignment process is supplied while the clean cleaning substrate is used, whereby contaminants such as particles adhering to the substrate stage are adsorbed on the cleaning substrate and are collected. This easily removes the contamination of the substrate stage by cleaning without stopping the operation of the exposure unit EXP. The cleaning substrate which has adsorbed the contaminants after the cleaning process is cleaned again in the cleaning processing unit SOAK1.

The construction of the substrate processing apparatus SP according to the present invention is not limited to the configuration shown in FIGS. 1 to 4. However, various modifications may be made to the construction of the substrate processing apparatus SP if a transport robot circulatingly transports a substrate W to a plurality of processing parts whereby predetermined processes are performed on the substrate W.

While the invention has been described in detail, the foregoing description is in all aspects illustrative and not restrictive. It is understood that numerous other modifications and variations can be devised without departing from the scope of the invention.

What is claimed is:

1. A method of processing a substrate, said method including transporting a substrate subjected to a resist coating process in a substrate processing apparatus to an exposure apparatus to expose said substrate in a pattern in said exposure apparatus, and then transporting said substrate back to said substrate processing apparatus to perform a development process on said substrate in said substrate processing apparatus, said method comprising the steps of:
a) transporting a dummy substrate from said exposure apparatus to said substrate processing apparatus, said dummy substrate being used during the adjustment of an exposure position of a pattern image in said exposure apparatus;
b) cleaning said dummy substrate in said substrate processing apparatus; and
c) transporting said dummy substrate subjected to the cleaning from said substrate processing apparatus back to said exposure apparatus.

2. The method according to claim 1, wherein
said step b) includes the step of supplying hydrofluoric acid to said dummy substrate to perform surface preparation.

3. The method according to claim 1, wherein
said step b) is performed immediately before and/or immediately after the adjustment of the exposure position in said exposure apparatus.

4. The method according to claim 1, wherein
said step b) is performed at regular time intervals.

5. A substrate processing system including a substrate processing apparatus for performing a resist coating process and a development process on a substrate and an exposure apparatus for performing an exposure process on a resist-coated substrate, said substrate processing apparatus and said exposure apparatus being connected to each other, said substrate processing system comprising:
a housing part provided in said exposure apparatus for housing a dummy substrate for use during the adjustment of an exposure position of a pattern image;
a first transport element provided in said exposure apparatus for transporting the dummy substrate between said housing part and said substrate processing apparatus;
a cleaning part provided in said substrate processing apparatus for cleaning the dummy substrate; and
a second transport element provided in said substrate processing apparatus for transporting the dummy substrate received from said first transport element to said cleaning part and for transferring the cleaned dummy substrate received from said cleaning part to said first transport element.

6. The substrate processing system according to claim 5, wherein
said substrate processing apparatus further includes an interface part for connection to said exposure apparatus, and
said cleaning part and said second transport element are provided in said interface part.

7. The substrate processing system according to claim 5, wherein
said cleaning part includes a chemical solution supply part for supplying hydrofluoric acid to said dummy substrate.

8. The substrate processing system according to claim 5, wherein
said exposure apparatus includes a cleaning request part for transmitting a cleaning request signal for requesting the cleaning of the dummy substrate to said substrate processing apparatus, and
said substrate processing apparatus includes a cleaning control part for controlling and causing said second transport element and said cleaning part to perform the cleaning process on the dummy substrate when receiving the cleaning request signal from said cleaning request part.

9. The substrate processing system according to claim 5, wherein
said substrate processing apparatus includes a carrying-out request part for transmitting to said exposure apparatus a carrying-out request signal for requesting said exposure apparatus to transport the dummy substrate outwardly therefrom, and
said exposure apparatus includes a transport control part for controlling said first transport element so as to transport the dummy substrate to said substrate processing apparatus when receiving the carrying-out request signal from said carrying-out request part.

10. The substrate processing system according to claim 5, further comprising
a host computer for managing said substrate processing apparatus and said exposure apparatus,
wherein said exposure apparatus includes a transport control part for controlling said first transport element so as to transport the dummy substrate to said substrate processing apparatus when receiving a cleaning start signal from said host computer, and
wherein said substrate processing apparatus includes a cleaning control part for controlling and causing said second transport element and said cleaning part to perform the cleaning process on the dummy substrate when receiving the cleaning start signal from said host computer.

11. The substrate processing system according to claim 5, wherein
said exposure apparatus includes a transport control part for controlling said first transport element so as to transport the dummy substrate to said substrate processing apparatus, and
said substrate processing apparatus includes a cleaning control part for controlling and causing said second transport element and said cleaning part to perform the cleaning process on the dummy substrate,
said substrate processing system further comprising
a schedule management part for causing said transport control part and said cleaning control part to perform the cleaning process on the dummy substrate at regular time intervals.

12. A substrate processing apparatus for performing a resist coating process and a development process on a substrate, said substrate processing apparatus being disposed adjacent to an exposure apparatus for performing an exposure process on a substrate, said substrate processing apparatus comprising:
a cleaning part for cleaning a dummy substrate, the dummy substrate being used during the adjustment of an exposure position of a pattern image in said exposure apparatus; and
a transport element for transporting the dummy substrate received from said exposure apparatus to said cleaning part and for transferring the cleaned dummy substrate received from said cleaning part to said exposure apparatus.

13. The substrate processing apparatus according to claim 12, further comprising
an interface part for connection to said exposure apparatus,
wherein said cleaning part and said transport element are provided in said interface part.

14. The substrate processing apparatus according to claim 12, wherein
said cleaning part includes a chemical solution supply part for supplying hydrofluoric acid to said dummy substrate.

15. The substrate processing apparatus according to claim 12, further comprising
a cleaning control part for controlling and causing said transport element and said cleaning part to perform the cleaning process on the dummy substrate when receiving a cleaning request for requesting the cleaning of the dummy substrate from said exposure apparatus.

16. The substrate processing apparatus according to claim 12, further comprising
a carrying-out request part for transmitting to said exposure apparatus a carrying-out request signal for requesting said exposure apparatus to transport the dummy substrate outwardly therefrom.

17. The substrate processing apparatus according to claim 16, further comprising
a schedule management part for causing said carrying-out request part to transmit the carrying-out request signal at regular time intervals.
